(19) United States
(12) Patent Application Publication
(10) Pub. No.: US 2026/0125897 A1
(43) Pub. Date: May 7, 2026

(54) HIGH NOISE REDUCTION ACOUSTICAL PANELS WITH EXCELLENT AESTHETICS

(71) Applicant: USG INTERIORS, LLC, Chicago, IL (US)

(72) Inventors: Qing YU, Libertyville, IL (US); Bangji CAO, Naperville, IL (US); Wanwisa DAVIS, Westmont, IL (US); Timothy Joe MILLER, Mundelein, IL (US); Adam Warren KELLER, Grayslake, IL (US); Connor Jacob WIGAND, Pleasant Prairie, WI (US)

(21) Appl. No.: 18/935,181

(22) Filed: Nov. 1, 2024

(51) Int. Cl. E04B 1/86; B32B 5/24; B32B 17/02; E04B 1/84

(52) U.S. Cl. CPC E04B 1/86; B32B 5/24; B32B 17/02; B32B 2255/02; B32B 2255/20; B32B 2255/28; B32B 2262/101; B32B 2307/10; B32B 2307/51; B32B 2307/72; B32B 2307/7376; B32B 2419/06; E04B 2001/8461

(57) ABSTRACT

A high noise reduction acoustical panel including a base mat with a veil and a front coating, preferably at least 2 layers of the front coating, an optional back coating and an optional second back coating. The acoustical panel preferably has a NRC of about 0.90 or greater and a CAC rating of 30 or higher.

### FIELD OF THE INVENTION

The present disclosure relates to high noise reduction coefficient (NRC) acoustical panels (e.g., ceiling tiles, ceiling panels, wall tiles, and wall panels) with excellent, monolithic aesthetics as well as a method of manufacture for these desirable acoustical panels. The acoustical panels are for use in offices, conference rooms, healthcare settings (with HIPPA requirements), classrooms, dining rooms, food preparation areas, and other locations. The panel is laminated on the front with a veil and coated with at least two layers of a front coating and optionally coated on the back with a back coating. The panel typically has minimal peppering, acceptable airflow and NRC. The panel typically is not directional when viewed in harsh lighting. The panel typically has a LR (light reflection) of 0.85 or greater. In the present disclosure the term acoustical panel represents any acoustical wall panel or wall tile or ceiling panel or ceiling tile of any size.

### BACKGROUND OF THE INVENTION

Noise reduction acoustical panels, e.g., ceiling tiles, are often desired in residential and commercial setting. Many noise reduction ceiling tiles are marked with “peppers” on the surface, which are random spots and shadows, which are undesirable visually.

Additionally, acoustical panels with smooth surfaces and fine textures are becoming increasingly popular. Such acoustical panels are often laminated with a glass fibers scrim on the surface. Such laminated acoustical panels, e.g., ceiling tiles, are often subjected to harsh lighting (for example lighting coming in at low angles instead of perpendicular to a ceiling, depending on the application, window location, time of day and other factors). Harsh lighting can amplify small surface defects, making the ceiling appear patchy with undesirable and at time unacceptable appearance. The issue is sometimes address by labeling the ceiling tiles as “directional;” and requesting the ceiling tiles be installed in one direction only based on directional markings applied during the manufacturing process. Directional tiles have limitations such as, longer installation times, mistakes in installation (resulting in higher costs), and some visual defects under harsh lighting appear randomly and cannot be fully addressed by installing in one direction.

High performance acoustical panels with balanced ceiling performance, high LR, and smooth white surface are frequently used. When observed closely, these acoustical panels have numerous dark spots, referred to as “peppers”. While peppers may be harder to notice once the acoustical panels, e.g., ceiling tiles, are installed, they are very obvious in hand samples and low hanging areas.

Microscopic analysis has been carried out to understand these peppers. Peppers are important to NRC performance because most sound energy enters the ceiling tile through these peppers.

In the prior art, in acoustical panels, e.g., ceiling tiles, with a veil coated with a front coating, the front coating soaks into the veil and leaves fibers in the veil exposed on the ceiling time surface. The challenge of these acoustical panels are the orientation of fiber alignment creates defects under harsh lighting, such as peppers, patchiness, when the fiber orientation during veil formation is not completely random, and the exposed fibers can be damaged easily, resulting in low scrub resistance and low abrasion resistance.

U.S. Pat. No. 8,062,565 Mueller et al. and US 2012/0024625 Cao et al., incorporated herein by reference in its entirety, disclose non-woven materials that can be formed into an acoustical tile, for example with an inorganic base fiber and a synthetic thermal bonding fiber.

U.S. Pat. No. 9,243,401 Kragness et al., incorporated herein by reference in its entirety, discloses ceiling tiles with a nonwoven veil and a spray coating applied at about 115 dry g/m² to about 125 dry g/m².

U.S. Pat. No. 9,896,807 Englert et al., incorporated herein by reference in its entirety, discloses an acoustical tile including newsprint and perlite.

U.S. Pat. No. 10,696,594 Xu et al., incorporated herein by reference in its entirety, discloses acoustical tiles including a dried base mat without including glass fibers and without a laminate layer or coating and without perforations with a NRC of about 0.70 or greater, a density of about 10 pcf to about 12 pcf, and a thickness of about ½ to 1 inch.

US 2023/0035178 Xu et al., incorporated herein by reference in its entirety, discloses fibrous panels or basemats with a spray coating of 30-65 wt. % water, 2.5-10 wt. % binder and 0.01-10 wt. % additives. The coating is applied in a range of about 8 g/ft² to 25 g/ft².

U.S. Pat. No. 11,865,579 Brockwell et al., incorporated herein by reference in its entirety, discloses a coating process for finished fibrous panels including a basemat, a veil and a prime coat applied by curtain coating and a finish coat applied by spray coating. The veil may be a non-woven continuous glass fibers-type material that has a multi-directional and random, overlapping fibrous orientation which allows for air permeability and flow.

U.S. Pat. No. 9,909,310 Frank et al., incorporated herein by reference in its entirety, discloses an ceiling tile with a wet laid mineral fiber basemat, a non-woven porous glass fibers veil, and a light reflecting air permeable coating with good NRC and Ceiling Attenuation Class (“CAC”) performance. The front coat is an ceiling non-blocking paint with titanium dioxide and can be applied in two coats.

U.S. Pat. No. 11,885,129 Li et al., incorporated herein by reference in its entirety, discloses a ceiling tile with at least two coats of a transparent coating which creates pores at the surface and comprises a high glass transition temperature polymeric binder, which is brittle at room temperature and promotes cracking, titanium dioxide and particles. The pores result in improved sound absorption performance.

U.S. Pat. No. 10,208,477 McCartney et al., incorporated herein by reference in its entirety, discloses a fibrous panel with a basemat and a porous veil on at least one side of the basemat.

### SUMMARY OF THE INVENTION

The invention provides an aesthetically improved acoustical panel with minimal peppering and patchiness. The improved acoustical panel includes:
a basemat,
a veil comprising:
   15-55 wt. % glass fibers,
   40-60 wt. % mineral filler, typically calcium carbonate and/or titanium dioxide,
   25-35 wt. %, preferably 28-32 wt. %, more preferably 30-31 wt %, binder, and
wherein the glass fibers have a number average length of about 5-10 mm, preferably 6-7 mm,
wherein a first portion of the glass fibers in the veil has a diameter of 10-11 μm,
wherein a second portion of the glass fibers in the veil has a diameter of 6-7 μm,
wherein the veil has a base weight of 100 g/m² to 200 g/m², preferably 120 g/m² to 180 g/m², more preferably 130 g/m² to 180 g/m²,
a front coating comprising filler and binder at a front face of the acoustical panel,
wherein the front coating has a first layer comprising the filler and the binder and a second layer comprising the filler and the binder,
wherein the second layer has a higher weight per surface area than the first layer,
wherein the first layer and the second layer is present at a total weight per surface area of 11 to 15.5 g/ft², preferably 12.5-15.5 g/ft² on a dry basis of the front face of the acoustical panel,
wherein the first layer of the front coating is about 4-7 g/ft², typically 5.5-6.5 g/ft² on a dry basis of the front face of the acoustical panel and wherein the second layer of the front coating is about 5.5 to 10 g/ft², preferably 5.5 to 7 g/ft² or preferably 7 to 8.5 g/ft² on a dry basis of the front face of the acoustical panel, and
wherein the first layer of the front coating as applied has droplets of an average droplet diameter from 10 μm to 160 μm, preferably 20 μm to 150 μm, preferably with a majority of the droplets 50 μm to 100 μm,
wherein the second layer of the front coating as applied has droplets of an average droplet diameter from 10 μm to 160 μm, preferably 20 μm to 150 μm, preferably with a majority of the droplets 50 μm to 100 μm,
wherein the layers of the front coating are substantially uniformly applied but do not form a continuous film;
wherein spots on the acoustical panel having cross-sectional area of less than 0.3 mm², preferably less than 0.2 mm², are present from 1.5% to 5%, preferably 2 to 4% of total area of the front face of the acoustical panel,
wherein a number mean cross-sectional area of the spots is greater than 0.002 mm² and up to 0.012 mm², preferably up to 0.008 mm², preferably up to 0.006 mm², and
wherein a total area darkened with shadows and/or the spots is 1.5 to 17%, preferably 2 to 17%, more preferably 3 to 16%, furthermore preferably 3 to 15% of the total area of the front face of the acoustical panel.

A front coating is applied via spray coating on the veil and comprises filler and polymeric binder, wherein the front coating has a first layer and a second layer, and the second layer has a higher weight per surface area than the first layer, the total of the first layer and the second layer is applied at from 16 to 22 g/ft², more preferably 18-22 g/ft² total. The first layer of the front coating is applied at about 6-10 g/ft², for example 8-9 g/ft². The second layer of the front coating is applied at about 8 to 14 g/ft², preferably 8 to 10 g/ft² or preferably 10 to 12 g/ft².

In the present description, unless otherwise indicated, all coating amounts are the amounts as applied on a wet (liquid carrier/water inclusive) basis. Thus, these ranges are on a wet basis which includes liquid carrier. Typically the carrier comprises water. More typically the carrier is all or mainly water. The wet coatings as applied may contain 10 to 35 wt % liquid carrier which is removed as the coating dries.

Typically after drying the total of the first layer and the second layer of the front coating on a dry basis is present at from 11 to 15.5 g/ft², preferably 12.5-15.5 g/ft² total. The first layer of the front coating is about 4-7 g/ft², typically 5.5-6.5 g/ft². The second layer of the front coating is about 5.5 to 10 g/ft², preferably 5.5 to 7 g/ft² or preferably 7 to 8.5 g/ft².

The invention provides a nondirectional acoustical panel with a basemat, a veil comprising glass fibers, mineral filler and binder, and a front coating. In particular the invention provides a nondirectional acoustical panel comprising:
a basemat,
a veil comprising:
   15-55 wt. % glass fibers,
   40-60 wt. % mineral filler, typically calcium carbonate and/or titanium dioxide, and
25-35 wt. %, preferably 28-32 wt. %, more preferably 30-31 wt %, binder,
wherein the glass fibers have a number average length of about 5-10 mm, preferably 6-7 mm,
wherein a first portion of the glass fibers in the veil has a diameter of 10-11 μm,
wherein a second portion of the glass fibers in the veil has a diameter of 6-7 μm,
wherein the glass fibers are in a substantially uniform random orientation,
wherein the veil has a base weight of 100 g/m² to 200 g/m², preferably 120 g/m² to 180 g/m², more preferably 130 g/m² to 180 g/m², a front coating comprising filler and binder at a front face of the acoustical panel,
wherein the front coating has a first layer and a second layer,
wherein the second layer has a higher weight per surface area than the first layer.

A front coating is applied via spray coating on the veil and comprises filler and polymeric binder, wherein the front coating has a first layer and a second layer, and the second layer has a higher weight per surface area than the first layer.

The invention provides an acoustical panel with a high caliper low density basemat, a veil and a front coating, preferably 2 layers of the front coating sprayed in a fine mist and the second layer has more front coating than the first layer, and an optional back coating. The acoustical panel has minimal “pepper”, acceptable airflow (preferably CAC is 30 or higher) and NRC of 0.90 or higher, preferably 0.95 of higher, and is not directional when viewed in harsh lighting conditions.

The acoustical panel may be considered largely “pepper-free” when the total area of the spots is less than 4%, for example less than 3% or less than 3.6%, and/or the mean spots size is less than 0.015 mm. Additionally, the acoustical panel is less than 17%, preferably less than 16%, more preferably less than 15% total area darkened with spots and shadows.

The acoustical panel may have minimal “patchiness” and no directionality, meaning that the fibers in the veil are substantially uniformly randomly oriented and the acoustical panels have a monolithic appearance. This minimal patchiness and no directionality of the fibers improves the appearance of the acoustical panels, particularly under harsh lighting conditions.

Preferably the above described acoustical panels are a high noise reduction acoustical panel having an NRC is 0.90 or higher:
wherein the basemat comprises mineral wool, or glass wool, or a combination of mineral wool and glass wool; filler; and binder,
wherein the mineral wool, the glass wool, or the combination of mineral wool and glass wool of the basemat have a number mean diameter of at least 6 microns and is present in an amount of at least 80 wt. %, preferably at least 90 wt. %, based on the total weight of the basemat as dried, and
the binder of the basemat is present in an amount of about 4 wt. % to about 13 wt. %, preferably between about 4 wt. % and about 10 wt. %, based on the total dry weight of the basemat,
the basemat having a density of about 9 to 12.5 lb/ft3,
wherein the basemat is provided as a single layer having a thickness of 1 inch to 1.5 inches;
wherein the veil comprises:
   15-55 wt. % glass fibers,
   40-60 wt. % mineral filler, typically calcium carbonate and/or titanium dioxide, and
   25-35 wt. %, preferably 28-32 wt. %, more preferably 30-31 wt %, binder,
   wherein the binder preferably comprises cured polyvinyl alcohol binder and optionally cured styrene-acrylic polymer binder,
wherein the glass fibers have number average length of about 5-10 mm, preferably 6-7 mm,
wherein the first portion of the glass fibers in the veil has the diameter of 10-11 μm,
wherein the second portion of the glass fibers in the veil has the diameter of 6-7 μm; and
wherein the front coating results from the drying of a coating composition applied comprising:
   30-90 wt. % filler selected from particles of calcium carbonate, dolomite, titanium dioxide, barium sulfate, clay, mica, limestone, silica, talc, perlite, gypsum, wollastonite, calcite, aluminum trihydrate, a pigment and a combination thereof, and
   1-20 wt. % binder selected from a natural polymer, a modified natural polymer, a synthetic polymer and a combination thereof, preferably a polymer aqueous emulsion of vinyl acetate-acrylate,
   10-30 wt. % carrier comprising water, and
   1-10 wt. % optional additives.

Thus, the acoustical panel of the present invention may have an absence of a back coating, a second back coating, and/or an edge coating.

Typically the veil has a porosity indicated by Air Flow Permeability of 1000-1200 L/m²/s at 100 Pa.

The veil may have a tensile MD (N/50 mm) of >210, and tensile CD (N/50 mm)>190.

The invention includes a process of manufacturing an acoustical panel of the invention comprising:
applying to a front side of the basemat a veil comprising:
   15-55 wt. % glass fibers,
   40-60 wt. % mineral filler, typically calcium carbonate and/or titanium dioxide,
   25-35 wt. %, preferably 28-32 wt. %, more preferably 30-31 wt %, binder, and
wherein the glass fibers have a number average length of about 5-10 mm, preferably 6-7 mm,
wherein a first portion of the glass fibers in the veil has a diameter of 10-11 μm,
wherein a second portion of the glass fibers in the veil has a diameter of 6-7 μm,
wherein preferably the glass fibers are in a substantially random orientation,
wherein the veil has a base weight of 100 g/m² to 200 g/m², preferably 120 g/m² to 180 g/m², more preferably 130 g/m² to 180 g/m²,
spray coating the veil with a first layer of a front coating comprising filler and binder, drying or substantially drying the first layer, wherein preferably the first layer of the front coating is applied and then dried in an oven;
then spray coating a second layer of the front coating comprising filler and binder to the first layer, wherein the first layer of the front coating may be the same or different in composition from the second layer of the front coating, preferably the first layer and the second layer have the same composition of the front coating,
wherein the second layer is applied with a greater weight per surface area than the first layer,
wherein a total of the first layer and the second layer of the front coating on a dry basis is present at from 11 to 15.5 g/ft², preferably 12.5-15.5 g/ft² on a dry basis of the front face of the acoustical panel;
wherein the first layer of the front coating is about 4-7 g/ft², typically 5.5-6.5 g/ft² on a dry basis of the front face of the acoustical panel, and the second layer of the front coating is about 5.5 to 10 g/ft², preferably 5.5 to 7 g/ft² or preferably 7 to 8.5 g/ft² on a dry basis of the front face of the acoustical panel resulting from:
applying the first layer and the second layer by the spray coating at a total weight per surface area of 16 to 22 g/ft² of the front face of the acoustical panel on a carrier inclusive basis,
wherein the first layer of the front coating is applied at a weight per surface area of 6-10 grams/square foot, preferably 8-9 g/ft² on a carrier inclusive basis, and the second layer of the front coating is applied at a weight per surface area of 8-14 g/ft², preferably 8 to 10 g/ft² or preferably 10-12 g/ft² of the front face of the acoustical panel on a carrier inclusive basis,
wherein the first layer of the front coating as applied has droplets of an average droplet diameter from 10 μm to 160 μm, preferably 20 μm to 150 μm, preferably with a majority of the droplets 50 μm to 100 μm,
wherein the second layer of the front coating as applied has droplets of an average droplet diameter from 10 μm to 160 μm, preferably 20 μm to 150 μm, preferably with a majority of the droplets 50 μm to 100 μm,
wherein the layers of the front coating are substantially uniformly applied but do not form a continuous film,
wherein spots on the acoustical panel having cross-sectional area of less than 0.3 mm², preferably less than 0.2 mm², are present from 1.5% to 5%, preferably 2 to 4% of total area of the front face of the acoustical panel,
wherein a number mean cross-sectional area of the spots is greater than 0.002 mm² and up to 0.012 mm², preferably up to 0.008 mm², preferably up to 0.006 mm² of the front face of the acoustical panel, and
wherein a total area darkened with shadows and/or the spots is 1.5 to 17%, preferably 2 to 17%, more preferably 3 to 16%, furthermore preferably 3 to 15% of the total area of the front face of the acoustical panel.

Advantages of the present invention may become apparent to those skilled in the art from a review of the following detailed description, taken in conjunction with the examples, and the appended claims. It should be noted, however, that while the invention is susceptible of examples in various forms, described hereinafter are specific examples of the invention with the understanding that the present disclosure is intended as illustrative, and is not intended to limit the invention to the specific examples described herein.

As used in the present specification at the very least, and not as an attempt to limit the application of the doctrine of equivalents to the scope of the claim, each numerical parameter modified by the term “about” should at least be construed in light of the number of reported significant digits and by applying ordinary rounding techniques.

The acoustical panel of the present invention may be any wall panel or wall tile or ceiling panel or ceiling tile of any size.

### BRIEF DESCRIPTION OF THE DRAWINGS

FIG. 1 shows an acoustical panel of the present invention.

FIGS. 2A and 2B are photographs of an acoustical panel with a fine textured mixed diameter fiber veil with a prior art front coating and an acoustical panel with a medium textured same diameter fiber veil with a prior art front coating.

FIGS. 3A-D shows images which were analyzed for pepper measurement. FIG. 3A is a raw grayscale comparative example, FIG. 3B is a processed two phase image of the comparative example of FIG. 3A. FIG. 3C is a raw grayscale inventive example.

FIG. 3D is a processed two phase image of the inventive example of FIG. 3C.

FIG. 4 is a histogram showing an example of a substantially uniformly random orientation of fibers in the veil.

FIG. 5 schematically shows crossing fibers and their angles for a veil.

FIG. 6 is a process flow diagram for making the acoustical panels of the invention.

FIGS. 7A, 7B and 7C are photographs of an acoustical panel with a veil (FIG. 7A), a veil with one layer of front coating (˜18 g/ft²) (FIG. 7B) and a veil with two layers (˜9 g/ft² for each layer) of front coating (FIG. 7C).

FIGS. 8A and 8B are photographs of microscopic views of a prior art acoustical panel with large peppers (FIG. 8A) and another prior art acoustical panel with smaller peppers that are harder to see (FIG. 8B).

FIG. 9 is a photograph of the present invention showing minimal peppering and minimal patchiness.

FIG. 10 is a photograph of a veil without any front coating under harsh lighting, showing “patchiness”.

FIGS. 11A and 11B are photographs of microscopic images of the present invention's basemat with veil and one layer of 16 g/ft² front coating (13a) and the present invention's basemat with veil and two layers of 8 g/ft² each front coating.

FIGS. 12A, 12B, 12C, 12D are photographs of optical microscopy images of the present invention with two layers of 9 g/ft² each front coating under 7× (top left), 20× (top right), 50× (bottom left and 100× (bottom right).

FIGS. 13A, 13B, 13C, 13D are photographs of optical microscopy images of the present invention with two layers of front coating with total coating around 18-22 g/ft². FIG. 13A (top left) is 8 g/ft² and then 10 g/ft² front coating. FIG. 13B (top right) is 8 g/ft² and then 12 g/ft² front coating. FIG. 13C (bottom left) is 10 g/ft² and then 10 g/ft² front coating. FIG. 13D (bottom right) is 10 g/ft² and then 12 g/ft² front coating.

FIGS. 14A and 14B are photographs of the prior art showing peppering and the present invention, respectively.

### DETAILED DESCRIPTION OF THE INVENTION

A high noise reduction acoustical panel with a total area of spots less than 4%, and/or the number average spot area is less than 0.02 mm², and/or the total area darkened with spots and/or shadows is less than 17% comprises a basemat, a veil, and at least two layers of a front coating comprising a filler and a polymeric binder applied in a first layer and a second layer via spray coating, wherein the second coating is preferably applied with greater weight per surface areas.

A high noise reduction nondirectional acoustical panel comprises a basemat, a veil with substantially randomly uniformly oriented fibers and a first portion of the fibers having an average diameter of 10-12 μm, and a second portion of the fibers having an average diameter of 6-7 μm, and a front coating comprising a filler and a polymeric binder applied in a first layer and a second layer via spray coating, wherein the second coating is preferably applied with greater weight per surface areas.

A noise reduction acoustical panel comprising a basemat comprising at least about 80 wt. % mineral wool, glass wool or a combination thereof having a number mean diameter of at least about 5 microns and between about 1 wt. % and about 10 wt. % of a binder, based on the total basemat as dried, a veil with substantially randomly uniformly oriented fibers and a first portion of the fibers having an average diameter of 10-12 μm, and a second portion of the fibers having an average diameter of 6-7 μm, and a front coating comprising a filler and a polymeric binder, wherein the filler comprises a combination of 1-4 μm calcium carbonate and 5-10 μm calcium carbonate, in a weight ratio of 1.5:1 to 5.5:1 and is applied in a first layer and a second layer via spray coating, wherein the second coating is preferably applied with greater weight per surface areas, and the acoustical panel has an NRC of 0.90 of higher, preferably 0.95 or higher, 0.90-1.0, and/or a CAC of 30 or higher, and/or an LR of 0.85 or greater.

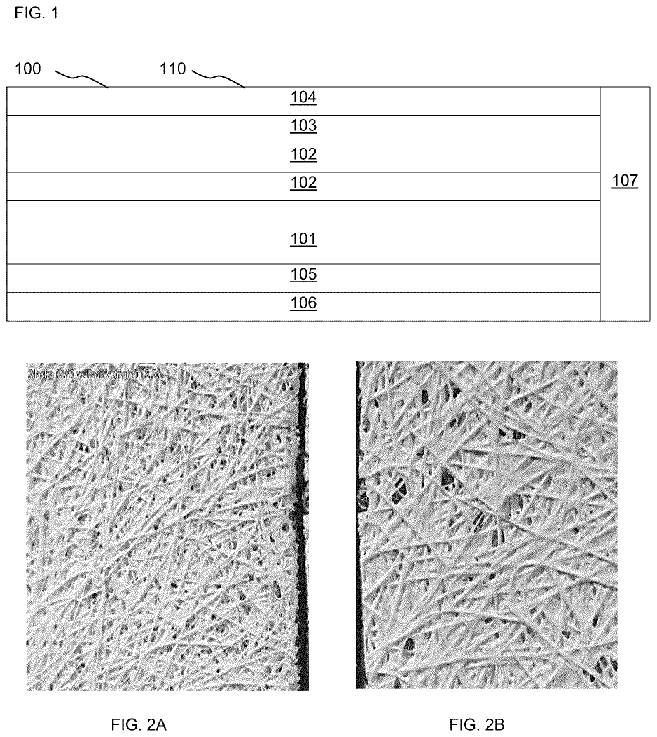

FIG. 1 shows high noise reduction acoustical panel 100 of the present invention having a basemat 101, a veil 102, a first layer of a front coating 103, a second layer of a front coating 104, an optional back coating 105, an optional second back coating 106 and an optional edge coating 107. The high noise reduction acoustical panel 100 has a front face 110.

### Basemat

In some embodiments, the basemat comprises a front side and a back side, the front side being opposite to the back side. In some embodiments, the front side may be facing towards a building space or room environment and the back side may be a rear side which is concealed from view when the basemat is mounted.

Some embodiments provide that the basemat further includes peripheral lateral sides extending all the way around a core which collectively define a perimeter edge or “edge” of the basemat. In some embodiments, the perimeter edge may have a square or rectangular edge profile, but other suitable edge profiles may be provided.

In some embodiments, the veil comprises an outward side and an inward side, the outward side being opposite to the inward side. In some embodiments, the outward side may be a front side which is facing towards a building space or room environment and the inward side may be a rear side which is concealed from view when the basemat is mounted.

In some embodiments, the front side of the basemat is joined to the inward side of the veil with an adhesive. In some embodiments the adhesive may be a pressure sensitive adhesive, a hot melt adhesive, or a combination thereof. In some embodiments, the adhesive comprises a hot melt adhesive. In some embodiments, the adhesive comprises a pressure sensitive adhesive. In some embodiments, the adhesive comprises polyvinyl acetate. In some embodiments, the adhesive comprises ethylene vinyl-acetate (EVA).

In some embodiments, the front coating may be applied to the outward side of the veil. In some embodiments, the front coating may be applied to the outward side of the veil before or after the veil is adhered to the front side of the basemat. In some embodiments, the outward side of the veil to which a front coating is applied is referred to as the “outward surface”.

In some embodiments the basemat may be formed from an inorganic fiber. Some embodiments provide that the fiber may be selected from mineral wool, slag wool, rock wool, fiberglass (glass wool), and a combination of two or more thereof. In some embodiments, the basemat may be formed from an organic fiber, such as cellulosic fibers selected from wood fibers, paper fibers, or cotton linters. In some embodiments, the inorganic fiber and/or the organic fiber may come from a recycled source.

The disclosed basemats may contain mineral wool or glass wool or combinations thereof of the type conventionally used in acoustical panels. Mineral wool in an acoustical panel increases the sound absorption (NRC) of the acoustical panel. In general, the higher the amount of mineral wool the better the sound absorption. Mineral wool also advantageously gives bulking to the slurry during formation of the core. Mineral wool, also known as mineral fiber, mineral cotton, mineral fiber, man-made mineral fiber (MMMF), and man-made vitreous fiber (MMVF), is a general name for fiber materials that are formed by spinning or drawing molten minerals (or “synthetic minerals” such as slag and ceramics). The mineral wool may be any of the conventional mineral fibers prepared by attenuating a molten stream of basalt, granite, or other vitreous mineral constituent. The molten mineral is either drawn linearly through orifices, commonly referred to as textile fiber, or it is recovered tangentially off the front of a spinning cup or rotor, commonly referred to as wool fiber. Preferably the mineral wool is slag wool or basalt wool. Slag wool is a mineral wool made usually from molten blast-furnace slag by the action of jets of steam under high pressure. On a dry basis, the mineral wool, the glass wool, or the combination of mineral wool and glass wool in the basemats and processes of the present invention may be present in an amount ranging from about 70 wt. % to about 95 wt %, 65 wt. % to about 90% wt. %, more preferably about 80 wt. % to about 92 wt. %, most preferably about 85 wt. % to about 92 wt. %, typically at least 80 wt. %, preferably at least 90 wt. %, based on the dry (water free) solids weight of the substrate. Typically on a dry basis, the mineral wool, the glass wool, or the combination of mineral wool and glass wool in the basemats and processes of the present invention may be present in an amount ranging from present in an amount of at least 80 wt. %, preferably at least 90 wt. %, based on the total weight of the basemat as dried.

Glass fibers are not mineral wool. The mineral wool, the glass wool, or the combination of mineral wool and glass wool of the basemat have a number mean diameter of at least about 5 microns.

Typically, mineral fibers have a number mean diameter of about 2 microns to about 10 microns, typically about 5 microns to about 10 microns, or typically about 6 microns to about 10 microns. The mineral fibers may also include as much as about 20% to about 60% unfiberized material, which is referred to in the art as shot.

The basemat has a density of about 9 to 16 lb/ft3, typically about 9 to 12.5 lb/ft3.

The basemat may be provided as a single layer having a thickness of about ½ inch to 2 inch, typically ⅝ inches to 2 inches, more typically 0.75 to 1.5 inch, preferably 1 inch to 1.5 inches.

The overall acoustical panel density is 10-20 lb/ft³, preferably 10-15 lb/ft³.

In some embodiments, the basemat may include non-fibrous fillers, such as kaolin clay, calcium carbonate, limestone, silica, vermiculite, ball clay or bentonite, talc, mica, gypsum, perlite, titanium dioxide, sand, barium sulfate, dolomite, polymers, wollastonite, calcite, aluminum trihydrate, pigments, zinc oxide, and zinc sulfate. In some embodiments the basemat may include from about 0 wt. % to about 25 wt. % of the non-fibrous filler. In another embodiment, the basemat may comprise expanded perlite in an amount ranging from about 0.1 wt. % to about 50 wt. % based on the weight of the basemat.

In some embodiments, the basemat may comprise a binder. Some embodiments provide that the binder may be selected from granular starches, polymers, and a combination thereof. In some embodiments the basemat may include between about 1 wt. % to about 35 wt. % of binder. The binder of the basemat may be present in an amount of about 4 wt. % to about 13 wt. %, preferably between about 4 wt. % and about 10 wt. %, based on the total weight of the basemat as dried. In some embodiments the basemat may include between about 3 wt. % to about 10 wt. % of binder. In some embodiments the basemat may include between about 4 wt. % to about 6 wt. % of binder.

The granular starches may include pearl cornstarch, wheat starch, and potato starch. In some embodiments, the polymers may be produced from one or more of the following monomers vinyl acetate, vinyl propionate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methylacrylate, styrene, butadiene, epoxy, melamine. In some embodiments, the polymers may include polyesters, polyethers, polystyrene, natural and modified natural polymers, polyvinyl chloride, polyvinyl alcohol, polyvinyl acetate, polymethyl methacrylate, and other acrylate or vinyl polymers. In some embodiments, the polyesters are derived from a di or poly-functional hydroxyl compound and a di or poly-functional carboxylic acid compound or anhydride compound.

Starch may or may not be cooked prior to use. A starch gel may be prepared by dispersing starch particles in water and heating the slurry until the starch is fully or partially cooked and the slurry thickens to a viscous gel. However, if conventional hydropulped fibers are used as a supplemental source of fiber, they may be incorporated into the starch slurry prior to cooking. The cooking temperature of the starch slurry should be closely monitored to assure the desired degree of swelling of the starch granules. The cooking temperature for cornstarch can range from about 160° F. (71° C.) to about 195° F. (90° C.). Starch may also be used as a binder without pre-cooking the starch, because it forms a gel during the process of drying the base mat. Cornstarch is the preferred binder.

Increased binder content, in the form of starch, can be used to increase strength (MOR-modulus of rupture (psi)) and hardness and enhance the cutability of the finished tiles/panels. On a dry basis, the starch is present from 0 wt % to about 10 wt %, preferably from about 1 wt % to about 5 wt %, more preferably from about 2 wt % to about 4 wt % in the basemat.

The latex binder may include polyacrylic polymer or copolymer, a polyester polymer or copolymer, a polyvinyl polymer or copolymer, an acrylo-polyester, and mixtures thereof.

In some embodiments, the basemat may further include additional additives such as dispersants, flocculants, defoaming agents, fungicides, biocides, and a combination thereof.

An ingredient of some embodiments of basemat is a perlite. Expanded perlite is preferred for its low cost and performance. The expanded perlite provides porosity and “loft” in the final product, which enhances ceiling properties.

On a dry basis the perlite, of either the high or low density type, may be present from about 0 wt % to about 25 wt %, preferably about 7 wt % to about 12 wt %, more preferably about 8 wt % to about 10 wt %, or 0 to about 10 wt. % in the basemats of the present invention.

Gypsum may optionally be included in the basemats. The gypsum is calcium sulfate dihydrate, CaSO₄·2H₂O. Gypsum has limited solubility in water and acts as a flocculent. When included, gypsum is present, on a dry basis, from 0 wt % to about 5 wt %, preferably about 0.5 wt % to about 3 wt %, more preferably about 0.5 wt % to about 2 wt % in the basemat. In some instances, acoustical panels of the invention, as well as the dried base mat and the slurry in the process for making the acoustical panel of the invention, can an absence of gypsum, if desired.

The basemat may be free of a cellulose. The basemat may be free of glass beads. The basemat may be free of perlite. The basemat may be free of clay, free of calcium carbonate, free of magnesium carbonate, and/or free of vermiculite.

The basemat to which a veil and a coating on the veil is applied may also be suitably any fibrous panel (e.g., an acoustical panel or acoustical panel) known in the art and prepared by methods known in the art, including acoustical panels prepared by a water-felting method. Suitable commercial acoustical panels for use in accordance with the present disclosure include, for example, RADAR™ brand acoustical panels available from USG Interiors, Inc. of Chicago, III. The RADAR™ brand panel is a water-felted slag wool or mineral wool fiber panel having a ⅝″ thickness and the following composition: 1-75 wt. % slag wool fiber, 5-75 wt. % expanded perlite, 1-25 wt. % cellulose, 5-15 wt. % starch, 0-15 wt. % kaolin, 0-80 wt. % calcium sulfate dehydrate, less than 2 wt. % limestone or dolomite, and less than 2 wt. % vinyl acetate polymer or ethylene vinyl acetate polymer. The diameters of the mineral wool fibers vary over a substantial range, e.g., 1 to 20 microns, and most of the fibers are in the range of 3 to 8 microns in diameter. The lengths of the mineral fibers range from about 1 mm to about 8 mm. For example, acoustical panels and the preparation thereof are described in, for example, U.S. Pat. Nos. 1,769,519, 3,246,063, 3,307,651, 4,911,788, 6,443,258, 6,919,132, and 7,364,015, each of which is incorporated herein by reference. The basemat may have any suitable porosity to achieve the required acoustic performance, for example, a porosity in a range of about 100 l/m²/s to about 2500 l/m²/s, about 500 l/m²/s to about 2000 l/m²/s, about 1000 l/m²/s to about 1500 l/m²/s, about 100 l/m²/s to about 1500 l/m²/s, about 500 l/m²/s to 1000 l/m²/s, about 1000 l/m²/s to about 2500 l/m²/s, or about 1500 l/m²/s to about 2000 l/m²/s

In some embodiments, the basemat is prepared according to the wet-felting process. In the wet-felting process, an aqueous slurry of the panel-forming materials including mineral wool, expanded perlite, starch and minor additives, are deposited onto a moving wire screen, such as a Fourdrinier or cylinder former. On the wire screen of a Fourdrinier, a wet mat is formed by dewatering the aqueous slurry by gravity and then optionally by vacuum suction. The wet mat is pressed to a desired thickness between press rolls for additional dewatering. The pressed mat is dried in ovens and then cut to produce acoustical panels. The basemat can then be converted to the panel of the present disclosure by application of the veil and the patterned coating composition of the disclosure. Generally, the patterned coating is applied after the veil is disposed on at least one side of the basemat, but it is also possible to apply the patterned coating to the veil and then to laminate the veil to the basemat.

In some embodiments, the basemat may be prepared by air-lay or direct-lay or other methods known in the art for preparing substrates as described herein.

In some embodiments, the basemat may be prepared by a method for manufacturing a lightweight, sag-resistant structural panel on a moving foraminous support wire which comprises the steps of:
forming a dilute aqueous furnish comprising a mineral fiber material;
adding a binder which consists of from about 20 wt. % to 100 wt. % of an anionically stabilized resin latex and from 0 wt. % to about 80 wt. % of starch based on the dry weight of total binder solids;
adding a cationic flocculating agent selected from guar gum and a polyacrylamide having a molecular weight of about 1-12 million and at least about 5 mole percent of a cationic component to the furnish in an amount sufficient to coat the mineral fiber material and flocculate the latex binder to coat the mineral fiber surfaces;
after addition of the flocculating agent, providing a period of up to about one minute for a relatively quiescent flow of the furnish;
depositing the furnish on a water flooded section of the support wire to form a self-sustaining, open structure of entangled mineral fiber material having water-filled interstices; and
stripping the water from the interstices and drying the structure without collapsing it by passing air through it at a rate of from about 50 to about 350 cubic feet per minute per square foot of the surface at which the air is directed, as disclosed in U.S. Pat. No. 5,250,153 to Izard, et al., incorporated herein by reference.

### Additives for the Basemat

Fiberglass may optionally be included in the basemat to further increase the NRC of the acoustical panel of the invention. In some embodiments, glass fiber may be used with an absence of mineral wool. In some embodiments, glass fiber and mineral wool may be present.

When included, fiberglass may be present, on a dry basis, from about 0.1 wt % to about 90 wt %, preferably about 0.1 wt % to about 50 wt %, more preferably about 0.5 wt % to about 30 wt % in the basemat.

The acoustical panel of the invention, as well as the basemat, may have an absence of polymer fibers unless included in a coating.

The acoustical panel of the invention, as well as the basemat, may have an absence of organic fibers (e.g., cellulosic fibers, paper fibers, and newsprint) unless included in a coating.

The acoustical panel of the invention, as well as the basemat, may have an absence of glass beads unless included in a coating.

The acoustical panel of the invention, as well as the basemat, may have an absence of clay unless included in a coating.

The acoustical panel of the invention, as well as the basemat, may have an absence of calcium carbonate unless included in a coating.

The acoustical panel of the invention, as well as the basemat, may have an absence of magnesium carbonate unless included in a coating.

The acoustical panel of the invention, as well as the basemat, may have an absence of all the following ingredients: glass beads, polymer fibers, organic fibers, clay, calcium carbonate, and magnesium carbonate unless included in a coating.

The acoustical panel of the invention, as well as the basemat, on a water free basis, may have an absence of inorganic material other than gypsum, and mineral wool and optionally glass fibers unless included in a coating. These exclusions are on a water free basis so it does not exclude water.

### High Caliper Low Density Basemat

An embodiment of basemat that may be employed in the present invention is a high caliper low density basemat. A high caliper low density basemat made from mineral fiber (including a mixture of fibers) with large overall median diameter is used for the acoustical panel. The basemat is made using a through-drying process to reduce drying time and increase noise reduction coefficient (NRC).

High caliper low density basemats, described in U.S. patent application Ser. No. 18/670,621, herein incorporated by reference in its entirety, used in some embodiments are manufactured by mixing an aqueous slurry comprising water and at least about 90 wt. % of mineral wool, glass wool, or a combination of mineral wool and glass wool and about 1 wt. % to about 10 wt. % of a binder; continuously flowing the aqueous slurry onto a moving foraminous support wire to form a wet basemat; dewatering the wet basemat, the dewatering step including pressing the wet basemat to a thickness of about 1.1 inches to about 2.0 inches or about 1.15 inches to about 1.55 inches; and pulling hot air through the wet basemat via vacuum through drying to form a dried basemat; laminating a porous scrim to a facing side of the dried basemat; wherein the ceiling panel has a density between about 7 pounds per cubic foot (lbs/ft3) to about 12 lbs/ft3, or between about 10 lbs/ft₃ to about 12 lbs/ft₃, wherein the ceiling panel has a thickness of greater than about 1.1 inches, typically about 1.1 inches to about 1.5 inches, wherein the ceiling panel has a NRC of about 0.80 to about 1.00, and wherein the ceiling panel has a ceiling attenuation class (CAC) of about 30 to about 50. The mineral wool and glass wool has an average diameter of at least about 5 microns on a dry basis, to produce an ceiling panel having a NRC of about 0.80 to about 1.00 and a CAC of about 30 to about 50.

High caliper low density basemats described in U.S. patent application Ser. Nos. 18/670,595 and 18/767,979 are herein incorporated by references in their entireties. The embodiments may use a single-layer, high-caliper basemat for a fibrous panel comprising mineral wool, glass wool, or a combination of mineral wool and glass wool, the mineral wool, the glass wool, or the combination of mineral wool and glass wool having a mean diameter of at least about 5 microns and being present in an amount of at least about 90 wt. %, based on the total weight of the single-layer, high-caliper basemat as dried, and a binder present in an amount of between about 1 wt. % and about 10 wt. %, based on the total weight of the single-layer, high-caliper basemat as dried, wherein the basemat is provided as a single layer having a thickness of greater than about 1.1 inches (2.80 cm) is disclosed.

Embodiments may use a high caliper low density basemat for a fibrous panel comprising wool fibers chosen from one or more in the group of mineral wool fibers and glass wool fibers, the wool fibers being present in an amount of at least about 90 wt %, based on the total weight of the basemat as dried, and a binder present in an amount of between about 1 wt. % and about 10 wt. %, based on the total weight of the basemat as dried, wherein the basemat has a density of about 7 pounds per cubic foot (lbs/ft³) to about 12.5 lbs/ft³ or between about 9 lbs/ft³ to about 12.5 lbs/ft³, and a thickness about 1 inch to 2 inches, typically 1 inch to 1.5 inches. The high caliper low density basemat may further comprise a mineral filler, for example a clay, perlite and/or vermiculite.

Another embodiment of the high caliper low density basemat is a fibrous panel comprising a single-layer, high-caliper basemat as disclosed herein and, a porous scrim having a first surface and a second surface, wherein the first surface is in contact with a facing side of the basemat is also disclosed.

On a dry (water free) basis, the latex may be present from about 1 wt % to about 8 wt %, preferably about 1 wt % to about 5 wt %, more preferably about 1 wt % to about 3 wt % in the high caliper low density basemat.

The total binder (i.e., latex plus starch, if included) may be present, on a dry basis, from about 4 wt % to about 13 wt %, preferably about 4 wt % to about 10 wt %, more preferably about 5 wt % to about 8 wt % in the high caliper low density basemats and processes of the present invention.

### Veil

The veil, also referred to as a glass fibers scrim, is applied to the basemat. A fine textured veil means a veil made from a portion of the glass fibers that has a diameter of 6-7 μm and a portion of the glass fibers that has a diameter of 10-11 μm. The glass fibers may have a number average length of about 5-10 mm, preferably 6-7 mm. The veil has a fine texture with good fiber dispersion to create a random fiber orientation for the acoustical panel. The veil comprises glass fibers with a first portion of fine glass fibers and a second portion of a thin (larger than fine) glass fibers, a mineral filler, and a binder.

In an embodiment, the veil comprises (on a dry basis):
15-55 wt. % glass fibers,
40-60 wt. % mineral filler, and
25-35 wt. %, preferably 28-32 wt. %, more preferably 30-31 wt %, binder.

A first portion of the glass fibers in the veil has a diameter of 10-11 μm, wherein a second portion of the glass fibers in the veil has a diameter of 6-7 μm. Preferably, the veil comprises fibers are in a substantially random orientation applied to the basemat.

The first portion of glass fibers are typically 5 to 50 wt. % of the veil and the second portion of glass fibers are 5 to 50 wt. % of the veil. More typically the first portion of glass fibers are 10 to 45 wt. % of the veil and the second portion of glass fibers are 10 to 45 wt. % of the veil.

For example, the lower limit of the first portion of glass fibers may be 5, 10, 20, 25, 30, 40 or 45 wt. % of the veil.

For example, the lower limit of the second portion of glass fibers may be 5, 10, 20, 25, 30, 40, or 45 wt. % of the veil.

For example, the upper limit of the first portion of glass fibers may be 50, 45, 35, 30, 25, 15 or 10 wt. % of the veil.

For example, the upper limit of the second portion of glass fibers may be 50, 45, 35, 30, 25, 15 or 10 wt. % of the veil.

In some embodiments, the non-woven veil comprises a filler selected from: calcium carbonate, aluminum trihydrate (ATH), magnesium hydroxide, dolomite, dolomitic limestone, and combinations thereof. In some embodiments, the filler will be substantially spherical and range in size from about 0.1 to about 300 microns.

In some embodiments the binders which can be used with the veil include an ingredient selected from polyvinyl alcohol, starch, a cellulosic resin, a polyamide, a polyacrylamide, a polyester, a polyolefin, a water soluble vegetable gum, an acrylic copolymer, and a combination of two or more thereof. In some embodiments, the polyolefins include polypropylene and polyethylene. Typically the binder is an aqueous polymer binder. More typically the aqueous polymer binder is provided as a Latex. For example, the veil may comprise a polymeric binder such as a polymer aqueous emulsion of vinyl acetate-acrylate. Or the binder may comprise polyvinyl alcohol, or styrene-acrylic polymer, or a blend thereof.

In some embodiments, the non-woven veil may further comprise a thickener or a whitener. According to one embodiment, thickeners may be present in an amount of about 0.1 wt. % to about 5 wt. % based on the solid binder content. In some embodiment, thickener may include a hydroxyethyl cellulose, a polyacrylamide, or a pH dependent thickeners, such as polyacrylates.

The veil has a base weight of 100 g/m² to 200 g/m², preferably 120 g/m² to 180 g/m², more preferably 130 g/m² to 180 g/m². The veil has a thickness of 0.5 mm or less, preferably from 0.25 to 0.5 mm, more preferably 0.3 to 0.4 mm. The veil has substantially uniform thickness.

FIG. 2A is a photograph that shows a prior art acoustical panel with a fine textured veil made from mixed diameter fibers with a prior art front coating. FIG. 2B is a photograph that shows a prior art acoustical panel with a medium textured veil made from a single diameter fiber with a prior art front coating.

### Front Coating

The front coating which is applied over the veil comprises 30-90 wt. % filler particles, 1-20 wt. % binder on a wet carrier/water inclusive basis. The front coating also includes a carrier, typically water, and optional additives.

The filler particles of the front coating include filler particles that comprise one or more of the following: calcium carbonate, dolomite, titanium dioxide, barium sulfate, clay, mica, limestone, silica, talc, perlite, gypsum, wollastonite, calcite, aluminum trihydrate, and a pigment.

Typically the filler particles include primary filler particles which act as inert filler, and optionally secondary filler particles that affect brightness, opacity, and/or color.

Typical primary fillers comprise one or more of the following: calcium carbonate, dolomite, clay, mica, limestone, silica, talc, perlite, gypsum, wollastonite, and calcite. There may be 30-70 wt. % primary filler on a wet carrier/water inclusive basis.

Typical secondary fillers comprise one or more of the following: titanium dioxide, aluminum trihydrate, barium sulfate, and a pigment. There may be 0 to 20 wt. %, typically 1-20 wt. % secondary filler on a wet carrier/water inclusive basis.

All measurements of front coating are for wet (water inclusive) front coating, unless otherwise specified.

TABLE 1 shows typical front coating compositions.

TABLE 1
typical front coating compositions

| | wt. % | Typical ingredient |
|---|---|---|
| Water | 10-30 | |
| Additives | 1-10 | |
| pH adjuster | 0.1-0.5 | 2-Amino-2-methyl-1-propanol |
| additive | | |
| Dispersing agent | 0.1-2.0 | |
| Defoamer | 0.15-1.0 | |
| Biocide and | 0.15-0.25 | Aqueous preservatives used to control the |
| Antimicrobial | | growth of mold, mildew bacteria and Fungi |
| Thickening agent | 0.15-2.0 | |
| CaCO3 (2 materials) | 30-70 | |
| Aqueous Polymer | 1-20 | Polymer Aqueous emulsion (40-60% solids) |
| binder (Latex) | | |
| TiO2 | 1-20 | |

Preferably the front coating used in the invention has a first plurality of relatively finer primary filler particles of a specific particle size and a second plurality of relatively larger fine primary filler particles and selected ratios of these first and second pluralities of primary filler particles to create a fine finish. The primary filler particles are typically a first portion of primary filler particles having a number average diameter of 1-4 μm, and a second portion of primary filler particles having a number average diameter of 5-10 μm, preferably the first portion and the second portion are in a weight ratio of 1.5:1 to 5.5:1.

The primary filler particles of the front coating typically contain calcium carbonate (CaCO3). Typically the primary filler particles are CaCO3. The primary filler particles are preferably calcium carbonate with a first portion of the calcium carbonate particles having a number average diameter of 1-4 μm, and a second portion of the calcium carbonate particles having a number average diameter of 5-10 μm, preferably the first portion and the second portion are in a weight ratio of 1.5:1 to 5.5:1.

Typically the secondary filler comprises TiO₂. TiO₂ is preferred because it provides advantageous brightness and opacity. Alumina Trihydrate I can also be used for brightness. Barium Sulfate can also be used for opacity.

Thus, an embodiment of the front coating comprises 30-70 wt. % calcium carbonate and 1-20 wt. % titanium dioxide.

D50 is the number average particle size. Preferably there is an absence of any materials that have a D50 number average particle size from 50 micron to 300 microns.

The binder of the front coating is one or more selected from: a natural polymer, a modified natural polymer, and a synthetic polymer.

In some embodiments the binders which can be used with the front coating of present invention include polyesters, acrylic latex, natural and modified natural polymers, and vinyl polymers. In some embodiments, the polymers can include one or more of the following monomers vinyl acetate, vinyl propionate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methylacrylate, styrene, butadiene, and an ester. Examples of natural and modified natural polymers are protein and carbohydrate polymers such as starch. In some embodiments, the binders may include polyesters, polyolefins, polyvinyl chloride, and combinations thereof. Typically the binder is an aqueous polymer binder. More typically the aqueous polymer binder is provided as a latex, for example a polymer aqueous emulsion of vinyl acetate-acrylate.

In some embodiments, the coating may further comprise additives, for example, dispersants, defoamers and viscosity modifying agents-such as thickening agents or thinning agents, or pH modifiers. The additives may be added as solids or as liquid solutions or suspensions having, for example, 20 to 80% active ingredient or solids. Dispersants can include polyacid hydrophobic copolymer dispersants. These copolymer dispersants are typically supplied in the neutralized from using either ammonium or alkali metal salts. For example, a dispersant such as a polymerization product based on polyethylene glycol, such as a polyether polycarboxylate, polynaphthalene sulfonate dispersants or branched polycarboxylates. In some embodiments, the coating comprises a salt of polycarboxylic acid or tetrasodium pyrophosphate as a dispersing agent. In some embodiments the defoamer may be defoamers are used to reduce entrapped air bubbles in the process. Polymers can entrap air during transportation and mixing. The defoamer can be oil based, water based, silicone based, EO/PO based, or alkyl polyacrylates, or a hydrophobic silica based in mineral oil. The coating may comprise hydroxyethyl cellulose as a thickener.

The front coating as applied includes a carrier that is a liquid, typically water, that evaporates by drying as the acoustical panel is made. The carrier is 10-35 wt. %, typically 10-30 wt. % and more typically 20-30 wt. %, for example 28-30 wt. %, of the front coating as applied on a wet (liquid carrier inclusive) basis. The carrier of the front coating is preferably water.

The front coating for acoustical panels is applied with a spray nozzle to uniformly produce fine sprayed particles, wherein the front coating is not a continuous film on the veil. Thus, there are holes in the front coating. Two layers of the front coating is more desirable to reduce surface “patchiness” of the veil. A slightly heavier second layer of the front coating can improve the NRC. The first layer spreads out and partially soaks into the veil. The second layer forms little “dots”, in a more 3-dimensional structure than the first layer, and is less spread out than the first layer. The 2 layers of the front coating do not appear as 2 separate layers after application to the veil.

As discussed above, the front coating uses a combination of calcium carbonate (5-10 μm) and a finer size (1-4 μm) calcium carbonate. The front coating formulation typically uses a finer grade calcium carbonate as a filler to help reduce the front coating droplet size. The first layer of the front coating tends to soak more into the veil, making the fibers visible. The second passing of the front coating helps hide the veil better, reducing the blotchy appearance. A spray nozzle with a fine tip (orifice) size of 0.025 to 0.042 inches, typically 0.027-0.035 inches, for example 0.029-0.041 inches or 0.029-0.033 inches, such as the flat tip of an airless spray gun helps to atomize the front coating into smaller droplets. Typically the nozzle has a fan spray pattern with a suitable fan width, for example a fan width of 4 to 20 inches, for example 10 to 20 inches or 15 to 20 inches. Typically the nozzle operates with a flow rate of 0.5-5 liters per minute, for example 3 to 5 liters per minute. The diameter of droplets applied for each layer of front coating are from 10 μm to 160 μm, preferably 20 μm to 150 μm with a majority of the droplets 50 μm to 100 μm. The droplet size is determined by coating drops on the acoustical panel. The present disclosure assumes the droplet size from the nozzle is the same as the droplet size on the acoustical panel.

The front coating is applied on the veil at from 16 to 22 g/ft², divided into at least two layers of the front coating.

The first layer of the front coating is applied on the veil at about 6-10 g/ft², or for example 8-9 g/ft². The second layer of the front coating applied at about 8 to 14 g/ft², preferably 8 to 10 g/ft² or preferably 10 to 12 g/ft². These ranges are for the coating applied wet and thus include carrier.

Typically after drying the total of the first layer and the second layer of the front coating on a dry basis is present at from 11 to 15.5 g/ft², preferably 12.5-15.5 g/ft² total. The first layer of the front coating is about 4-7 g/ft², typically 5.5-6.5 g/ft². The second layer of the front coating is about 5.5 to 10 g/ft², preferably 5.5 to 7 g/ft² or preferably 7 to 8.5 g/ft².

The first layer and second layer of the front coating comprise the same composition or different compositions, preferably comprise the same composition. In an embodiment, the first layer is smaller than the second layer of the front coating.

Preferably, the layers of the front coating create a more 3-dimensional structure on top of the veil with improved airflow and a higher NRC as compared to prior art.

Two layers or more of the front coating improves washability and scrubability of the acoustical panel. The front coating structure in two layer front coating process sits higher above the veil surface which shields the glass fibers, and improves scrubability and washability.

Two layers of the front coating on the veil on the basemat provides better Air Flow permeability, than a single layer of the front coating, and provides a higher NRC. Additional layers of front coating are optional. AFR, or air flow permeability, is the same as porosity mentioned earlier in this disclosure. The layers of the front coating are applied in sequence in the manufacturing process and may appear as a single layer in the final acoustical panel product.

### Optional Back Coating

An optional back coating comprises mineral filler and water and/or a binder and water. The optional back coating may be applied to the basemat on the side opposite the side on which the veil is applied. This optional back coating aids in noise reduction, and increasing CAC. The optional back coating may be applied in one or more layers, preferably in one layer.

An optional second back coating may be applied to the optional back coating. The optional second back coating may be applied in one or more layers, preferably in one layer. The optional second back coating comprises mineral filler, latex polymer and water.

An embodiment of the optional back coating comprises clay, water and additives. A preferred embodiment of the optional back coating comprises 45-85 wt. % clay, preferably clay particles having an average diameter of 0.10-1.5 μm and a particle size range of 0.1-20 μm.

All measurements of back coating are for wet (water inclusive) front coating, unless otherwise specified.

An embodiment of the second back coating comprises clay, water, additives and/or binder, for example, polymer binder, for example a latex polymer. A preferred embodiment of the second back coating comprises 40-70 wt. % clay, water, additives and 1-10 wt. % latex polymer. For example, the clay may have average particle size of 0.1-20 μm, typically 0.1-10 μm.

The back coatings can be applied in an amount to achieve a total surface weight (based on a dry/water-free weight of the coating) of about 0 grams per square foot (g/ft²) to about 45 g/ft², typically about 5 g/ft² to about 45 g/ft², about 10 g/ft² to about 40 g/ft², about 15 g/ft² to about 35 g/ft², or about 20 g/ft² to about 40 g/ft².

In some embodiments the binders of the second back coating which can be used with the present invention include polyesters, acrylic latex, natural and modified natural polymers, and vinyl polymers. In some embodiments, the polymers can include one or more of the following monomers vinyl acetate, vinyl propionate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methylacrylate, styrene, butadiene, and an ester. Examples of natural and modified natural polymers are protein and carbohydrate polymers such as starch. In some embodiments, the binders may include polyesters, polyolefins, polyvinyl chloride, and combinations thereof.

Typically first and second back coatings are applied, for example via roller coaters.

TABLE 1A lists typical 1st back coating.

TABLE 1A
Typical 1st Back Coating (typical
coating application 10-40 g/sq. ft)

| | wt. % | |
|---|---|---|
| Water | 35-75 | |
| Additive | 0.05-5 | Dispersing agent |
| Clay | 45-85 | |

TABLE 1B lists typical 2nd back coating.

TABLE 1B
Typical 2nd Back Coating (typical coating application 5-27 g/sq. ft)

| | wt. % | Typical ingredient |
|---|---|---|
| Water | 25-55 | |
| Additive | 0.01-5 | |
| pH adjuster additive | 0.01-1.0 | 2-Amino-2-methyl-1-propanol |
| Defoamer | 0.01-1.0 | |
| Biocide and Antimicrobial | 0.05-0.25 | Aqueous preservatives used to control |
| | | the growth of mold, mildew bacteria and |
| | | Fungi |
| Thickening agent | 0.1-1.5 | |
| Clay | 40-70 | |
| Polymer binder Aqueous | 1-10 | Polymer Aqueous emulsion |
| Polymer binder (Latex) | | |

### Optional Edge Coating

An optional edge coating may be applied to the edges of the basemat.

### Measurement of Spots and Dark Areas

The product has an excellent “pepper-free” appearance without “patchiness” (where the fibers are inadvertently aligned in the front coating and/or veil). The product has no directionality. The acoustical panel meets major performance targets including NRC, CAC, LR, low emission, good washability, good scrubability and good water repellency.

Pepper quantification is measured as follows. Peppers are referred to as spots and shadows as defined below. The surface of the acoustical panel is scanned at 2400 dpi in 8 bit grayscale. Scanned images are saved as lossless tiff files. Image analysis is then carried out using image analysis software (such as Olympus Stream Motion 2.4.2 software). After calibration to define the pixel size, images are modified with enhanced contrast and binary “particle” detection, or can be unmodified with trinary “particle” detection.

Each pixel of a grayscale image is represented with a number from 0 to 255 (8-bit integer). This number describes the brightness of that pixel, 0 is perfect black, 255 is perfect white. Pixels with values above 223 are white and considered not a spot nor a shadow (and not evaluated). Pixels with values inclusive of the range 188-223 are defined as shadows. Pixels with values below 188 are defined as spots.

After thresholding and segmenting, “count and measure” function is used to perform quantitative analysis on the detected spots and shadows, providing information such as spot count, test area, number of spots and shadows per unit area, and number mean size of the spots and shadows, referred to as particles. The minimum size of a spot has an area of 0.00101 mm². The maximum size of a spot is 0.2 mm².

TABLE 2 shows the summary of image analysis for Pepper quantification for a comparative sample having a basemat with a veil and coating (Comp.) and an inventive sample having a basemat with a different veil and different coating (Inventive). After multiple measurements, the average between the comparative examples and the inventive examples are shown in TABLE 2.

TABLE 2

| | | | | | | | | Total % |
|---|---|---|---|---|---|---|---|---|
| | | | | Mean | | Test | | Darkened |
| | | | Area | Size | % | Area | Spots/ | (spots and |
| Sample | | Count | (mm²) | (mm²) | Area | (mm²) | area | shadows) |
| Comp. | Spots | 26152 | 378.34 | 0.015 | 3.56 | 10579 | 2.46 | 17.15 |
| Comp. | Shadows | 66320 | 1437.85 | 0.022 | 13.58 | 10579 | 6.26 | |
| Inventive | Spots | 38188 | 243.72 | 0.006 | 1.95 | 12282 | 3.06 | 14.77 |
| Inventive | Shadows | 96224 | 1577.60 | 0.019 | 12.82 | 12282 | 7.78 | |

As is shown, the inventive product has higher number of spots, but lower total areas and much smaller mean size.

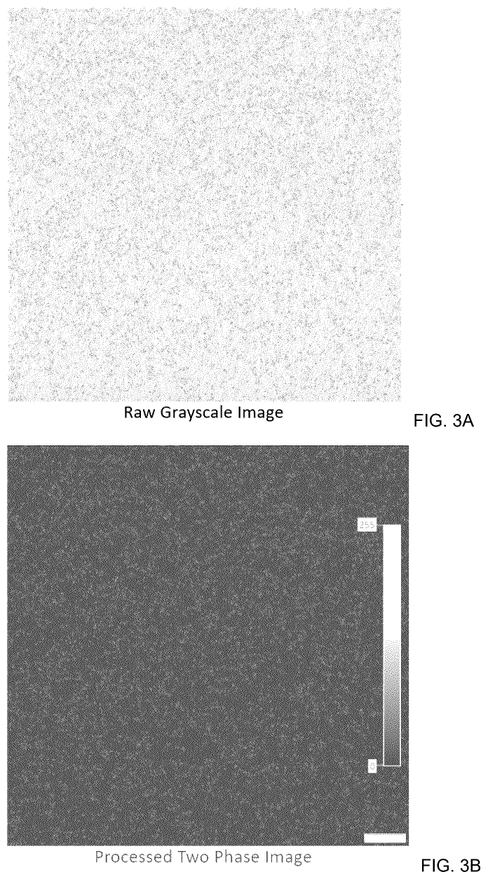

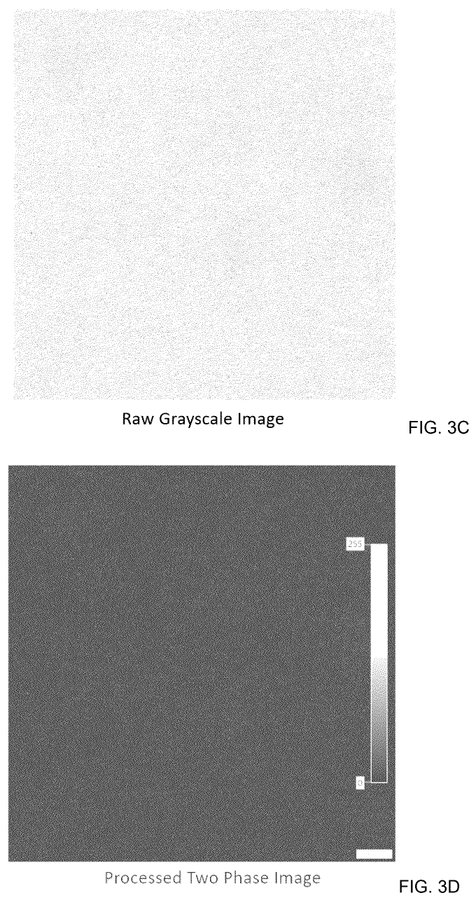

FIGS. 3A-2D show images of the faces (finished surfaces) of the comparative samples and inventive samples which were analyzed for pepper measurement. FIG. 3A is a raw grayscale of the comparative sample of TABLE 2. FIG. 3B is a processed two phase image of the comparative sample of FIG. 2A. FIG. 2C is raw grayscale of the inventive sample of TABLE 2. FIG. 3D is a processed two phase image of the inventive sample of FIG. 3C.

The acoustical panel may be considered largely “pepper-free” when the spots number mean cross-sectional area is up to 0.012 mm², greater than 0.002 mm², preferably up to 0.008 mm², preferably up to 0.006 mm², and wherein spots are less than 0.3 mm², preferably less than 0.2 mm². Additionally, the acoustical panel is less than 17%, preferably less than 16%, more preferably less than 15% of total area darkened with spots and shadows.

### NRC

Noise reduction coefficient (NRC) is a scale representation of the amount of sound energy absorbed upon striking a particular surface, with a NRC value of 0 indicating perfect reflection and a NRC of 1.00 representing perfect absorption of sound energy. The NRC value is an average of four sound absorption coefficients of the particular surface at frequencies of 250 HZ, 500 HZ, 1000 HZ, and 2000 HZ, which cover the range of typical human speech. In laboratory test of materials in a laboratory per ASTM C423-23, only the front of the sample is exposed to the sound energy, as would be the case in a typical installation. Under some circumstances NRC's greater than 1 may be obtained, but this is an artifact of the test method due to diffraction/edge to area effects.

### CAC

The Ceiling Attenuation Class (CAC) rating quantifies how much sound is lost when it is transmitted through the ceiling of one room into an adjacent room through a common plenum. A higher CAC rating indicates that the ceiling system allows less sound transmission. The CAC is measured using the test standard ASTM E 1414-21, in which the sound levels are measured in the source room and an adjacent room.

### Scrubability

Scrubability is evaluated using modified ASTM D2486-17, which is a cycles to failure test using abrasive scrubbing media on the acoustical panel's surface. Acoustical panels were scrubbed with a bristle brush and an abrasive scrub medium until there is damage. The control failed scrubability test at <25 cycles. The inventive acoustical panel can withstand 50-75 cycles.

### Water Repellency Test

Water repellency test was conducted by adding droplets of water onto the surface of the acoustical panels. A comparative sample with “pepper-free” appearance had water droplets soak into the surface in less than 1 minute. In comparison, the inventive product has water sitting on top for >30 min without soaking in.

### LR

LR generally increases with increasing overall front coating on the acoustical panel. A LR of 0.85 or greater can be reached with an overall front coating >14 g/ft².

Properties of the Acoustical panel

The acoustical panel has a total area of the spots is less than 4% and/or the mean spots size is less than 0.015 mm. Additionally, the acoustical panel is less than 17%, preferably less than 16%, more preferably less than 15%, more preferably less than 14.8% total area darkened with spots and shadows.

The acoustical panel has minimal patchiness (less than 5%, preferably less then 4%, preferably less than 2%, more preferably 0% of the surface area of the acoustical panel) and the acoustical panel has substantially no directionality with the fiber in the veil having substantially uniformly random orientation. An even distribution of fiber directionality is seen in the acoustical panel veil.

Substantially uniformly random fiber orientation, which may also be termed uniformly random fiber orientation, means when fibers in an acoustical panel are measured for their angles from the same defined line and are counted and, for example denoted in a histogram (angle from defined line is the x axis and number of fibers is the y axis), the number of fibers in each interval of 10 degrees from 0 to 180 will be the same plus or minus 20%, preferably plus or minus 10% relative to the average number of fibers in an interval.

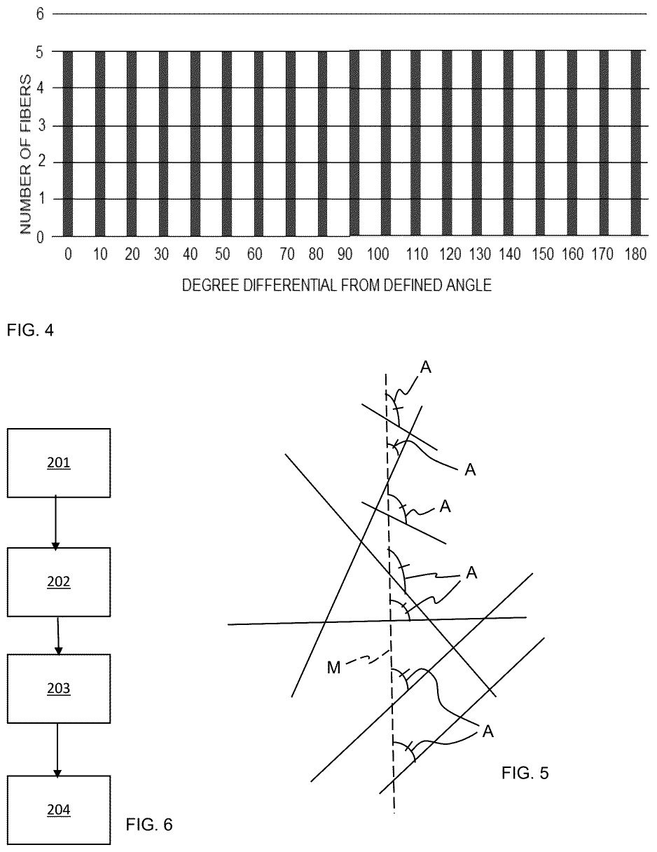

For example, FIG. 4 shows a hypothetical histogram of the number of fibers in each 10 degree interval of degree differential from the defined angle from 0 to 180 degrees in a hypothetical veil sample having a substantially uniformly random fiber orientation. As seen in FIG. 4 each interval has 5 fibers. Thus, the average number of fibers in an interval is 5. However, if half the intervals had 4 fibers and half the intervals had 6 fibers, the average number fibers in an interval would also be 5 fibers per interval. For an average of 5, plus or minus 20% defines a range from 4 to 6. The numbers 1-5 in the Y-axis are hypothetical and do not represent an actual example.

FIG. 5 schematically shows a line “M” and the angles “A” of the degree differential from 0 to 180 degrees formed by the fibers crossing the line “M”.

The angle “A” relative to the line “M” is always measured as the angle positioned clockwise relative to the top of the figure. In FIG. 5 line “M” is typically a line along the machine direction of veil production. Groups of fibers lined up to be substantially parallel to the machine direction M during veil manufacture tend to form the patches. The invention uniformly randomly orients the fibers to avoid significant amounts of parallel adjacent or contacting fibers. In a typical test the angles “A” are measured relative to a series of parallel lines “M” aligned with the machine direction and spaced, for example 1 inch, apart and extending from one edge of the veil to its opposed edge.

However, the randomness or lack of randomness would likewise be measured using as line “M” a straight line in any direction in the plane of the veil.

Typically, in a veil having the substantially uniformly random fiber orientation, the angles “A” of fibers in any 1 inch² of area of the veil surface relative to any line “M” through the fibers of that area if measured and counted will have a number of fibers in each interval of 10 degrees from 0 to 180 the same plus or minus 20%, preferably plus or minus 10% relative to the average number of fibers in an interval.

The veil surface has patchiness of less than 25%, preferably less than 10%, more preferably less than 5% of the surface area of the veil. A patch is an area on the surface (from 1 cm² to about 100 cm²) wherein the fiber in the veil surface is not substantially uniformly randomly oriented, and under harsh lighting (15 degree lighting or less) of the acoustical panel, a directionality in the patch is seen as an uneven light or dark shade. Preferably the surface area of an acoustical panel with a nondirectional veil that has substantially uniformly random fiber orientation has less than 5%, preferably less than 4%, preferably less than 2%, more preferably 0% patches, wherein the patches, if present, are each less than 1 cm² in area.

In embodiments, the acoustical panel of the invention has an NRC of about 0.80 or greater, 0.90 or greater, preferably about 0.95 or greater (e.g., about 0.75 to about 0.90), up to 1.0.

A further benefit of the invention is the acoustical panel achieves NRC of 0.90 or greater without perforations and fissures. Thus, the acoustical panel of the present invention may have an absence of perforations and fissures. However, the front of the acoustical panel or basemat can optionally be perforated and fissured to further improve its sound absorption performance.

The acoustical panel of the invention has a CAC of about 20 or higher, preferably 30 or higher, up to 50.

The acoustical panel of the invention has a LR of 0.85 or higher, preferably 0.90.

### Process of Manufacturing

A process of manufacturing a high noise reduction acoustical panel with excellent aesthetics is shown in FIG. 6. The basemat is made 201. The basemat can be ground or otherwise sanded on the front and/or back side to produce a relatively smooth surface, before any veil or optional back coating is applied.

A veil is applied to the front side of the basemat 202 through an adhesive.

To obtain a fine texture acoustical panel, a veil, which is a fine textured glass fibers scrim is typically employed.

Once such veil is applied to the front side of the basemat, a first layer of front coating is applied to the veil via spray coating 203. The first layer of the front coating is then preferably dried or substantially dried. The first layer is uniformly applied via spray coating with droplets having a diameter from 10 μm to 160 μm, preferably 20 μm to 150 μm with a majority of the droplets 50 μm to 100 μm, such that the distribution of the covered areas of the veil and uncovered areas of the veil is random, and at least 50% of the surface area of the veil is covered and the remainder is uncovered. The first layer of the front coating is applied wet at a weight per surface area of 6-10 g/ft², for example 8-9 g/ft².

A second layer of the front coating is applied to the first layer via spray coating 204. The second layer is uniformly applied via spray coating with droplets having a diameter from 10 μm to 160 μm, preferably 20 μm to 150 μm with a majority of the droplets 50 μm to 100 μm. A portion of the second layer lays on a portion of each of the covered and uncovered areas of the veil, and a portion of the uncovered areas of the veil remain uncovered by the second layer. The second layer of the front coating is applied wet at a weight per surface area of about 8 to 14 g/ft², preferably 8 to 10 g/ft² or preferably 10 to 12 g/ft². Preferably, the second layer has a higher weight per surface area than the first layer. Preferably, the first layer and the second layer are applied wet at a weight per surface area of are 16 to 22 g/ft², more preferably 18-22 g/ft² total as applied weight on a wet (carrier/water included) basis.

Typically after drying the total of the first layer and the second layer of the front coating on a dry basis is present at from 11 to 15.5 g/ft², preferably 12.5-15.5 g/ft² total on a dry basis. The first layer of the front coating is about 4-7 g/ft², typically 5.5-6.5 g/ft² on a dry basis. The second layer of the front coating is about 5.5 to 10 g/ft², preferably 5.5 to 7 g/ft² or preferably 7 to 8.5 g/ft² on a dry basis.

In an embodiment, the first layer and the second layer of the front coating do not result in two distinct layers of the front coating on the finished acoustical panel. In an embodiment, the first layer and the second layer of the front coating are not distinguishable on the finished acoustical panel.

Optionally, a back coating is applied via roll coating, curtain coating, spray coating, adhesives and other typical coating processes, to the back side of the basemat. The thickness of the back coating is up to 3 mm, preferably about 1.5 mm to about 2.0 mm.

Optionally, a second back coating is applied via roll coating, curtain coating, spray coating, adhesives and other typical coating processes, to the back coating. The second back coating may have the same composition or a different composition as the back coating.

Optionally, an edge coating is applied to one or more edges of the basemat.

If desired, the process for producing the acoustical panel may include: a grinding or sanding step, and/or a perforating or fissuring step.

### Spray Coating

The front coating is applied by spray coating at least two layers (two passes) of the front coating. The first layer of the front coating is applied wet at a weight per surface area of 6-10 g/ft², for example 8-9 g/ft². The second layer of the front coating is applied wet at a weight per surface area of about 8 to 14 g/ft², preferably 8 to 10 g/ft² or preferably 10 to 12 g/ft². Preferably, the second layer has a higher weight per surface area than the first layer. Preferably, the first layer and the second layer are applied wet at a weight per surface area of are 16 to 22 g/ft², more preferably 18-22 g/ft² total as applied weight on a wet (carrier/water included) basis. It is preferable that the first layer of the front coating is dried or substantially dried before the second layer of the front coating is applied. The droplets of the first layer have a diameter from 10 μm to 160 μm, preferably 20 μm to 150 μm with a majority of the droplets 50 μm to 100 μm. The droplets of the second layer have a diameter from 10 μm to 160 μm, preferably 20 μm to 150 μm with a majority of the droplets 50 μm to 100 μm. The droplets of the first layer may have the same diameter as the droplets of the second layer. The droplets of the first layer may have different diameter from the droplets of the second layer.

The spray process can be further optimized by considering spray fan shape, fan stability, nozzle wear and tear, clogging risk, etc. to balance between performance and operation. Coating usage of <6 g/ft² is difficult to achieve, as finer spray tip needed for lower usage tends to get blocked easily; therefore 6-8 g/ft² per layer is usually considered the minimum practical application rate.

All percentages and ratios used herein, unless otherwise specified, are by weight (i.e., wt %) unless otherwise indicated.

The following examples are presented to further illustrate some preferred examples of the invention and to compare them with conventional methods and compositions outside the scope of the invention. The invention is not limited by the following examples but rather is defined by the claims appended hereto.

### EXAMPLES

TABLE 3 shows the properties of veils A and B as used in the examples.

TABLE 3

| | Veil A | Veil B |
|---|---|---|
| Basis weight (g/m²) | 135 | 145 |
| Thickness (mm) | about 0.3 | about 0.4 |
| Fiber length (mm) | 6 | 6 |
| Fiber diameter (μm) | 6-7 & 10-11 mixed | 6-7 & 10-11 mixed |
| Binder % (LOI) | about 30-32% | about 30-32% |
| Tensile machine direction (MD) | >210 | >220 |
| (N/50 mm) | | |
| Tensile cross direction (CD) (N/50 mm) | >190 | >200 |
| Air flow permeability (L/m²/s at 100 Pa) | between 1000 | between 1000 |
| | and 1200 | and 1200 |
| Water drop (seconds) | >30 | >30 |

Veil A is thinner with lower basis weight at a higher binder % and higher density with lower airflow porosity (as compared to Veil B). Veil B had minimal patchiness/cloudiness, which leads to better finished aesthetics under critical lighting.

The front coating comprised a composition within the ranges of TABLE 4.

TABLE 4
front coating composition

| | wt. % | Ingredients |
|---|---|---|
| Water | 10-30 | |
| Additives | 1-10 | |
| pH adjuster additive | 0.1-0.5 | 2-Amino-2-methyl-1-propanol |
| Dispersing agent | 0.1-2.0 | |
| Defoamer | 0.15-1.0 | |
| Biocide and Antimicrobial | 0.15-0.25 | Aqueous preservatives used to control |
| | | the growth of mold, mildew bacteria and |
| | | Fungi |
| Thickening agent | 0.15-2.0 | |
| CaCO3 (2 materials) | 30-70 | |
| Aqueous Polymer binder (Latex) | 1-20 | Polymer Aqueous emulsion |
| TiO2 | 1-20 | |

The basemat comprises mineral wool, glass wool, or a combination of mineral wool and glass wool; filler; and binder.

### Example 1

Acoustical panels were prepared for comparison under harsh light. A basemat had Veil B from TABLE 3 applied.

A basemat with a veil, but no front coating, is shown in FIG. 7A (comparative example). Patchiness of the veil is apparent.

An acoustical panel with a basemat, a veil and one layer of front coating is shown in FIG. 7B (comparative example). The acoustical panel of FIG. 7B had one layer of about 18 g/ft² front coating. Patchiness is apparent.

In FIGS. 7A and 7B, comparative example acoustical panels with “peppers” or “patchiness” under harsh lighting are shown. Acoustical panels with darker peppers or shadows were selected and the areas of darker peppers are marked. The naked eye saw almost no abnormality in these areas, under the microscope, fiber orientation is directional, not random, in the marked areas. Most non-woven veils have fiber orientation in the machine direction of the manufacturing process, causing directionality.

An acoustical panel with a basemat, a veil and two layers of front coating is shown in FIG. 7C (inventive example). The acoustical panel of FIG. 7C had two layers of front coating of about 9 g/ft² each. This acoustical panel had the most uniform look, least “patchy” look, of all three examples.

### Example 2

As shown, the fibers in the veil were not substantially exposed on the surface because the front coating was substantially covering them, and the large amount of fine pores were not obvious to the naked eye, achieving a fine texture that is uniform under harsh light without losing acoustical performance. There is no directionality or patchiness under harsh lighting.

### Example 3

FIGS. 8A and 8B are examples of prior art acoustical panels under the same magnification and showing the “peppers” in the acoustical panels. FIGS. 8A and 8B are photographs of microscopic views of a prior art acoustical panel with large peppers (FIG. 8A) and another prior art acoustical panel with smaller peppers that are harder to see (FIG. 8B).

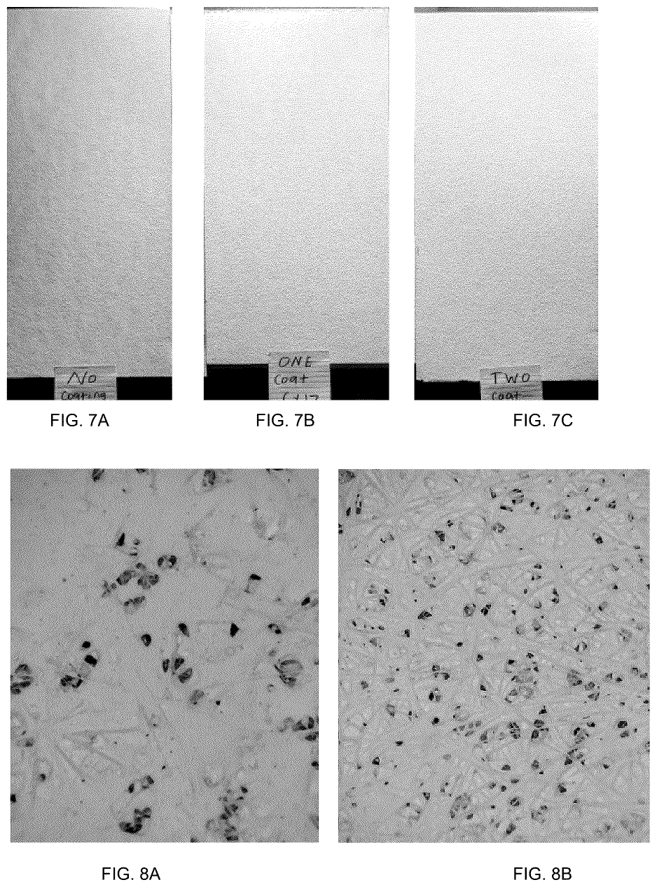

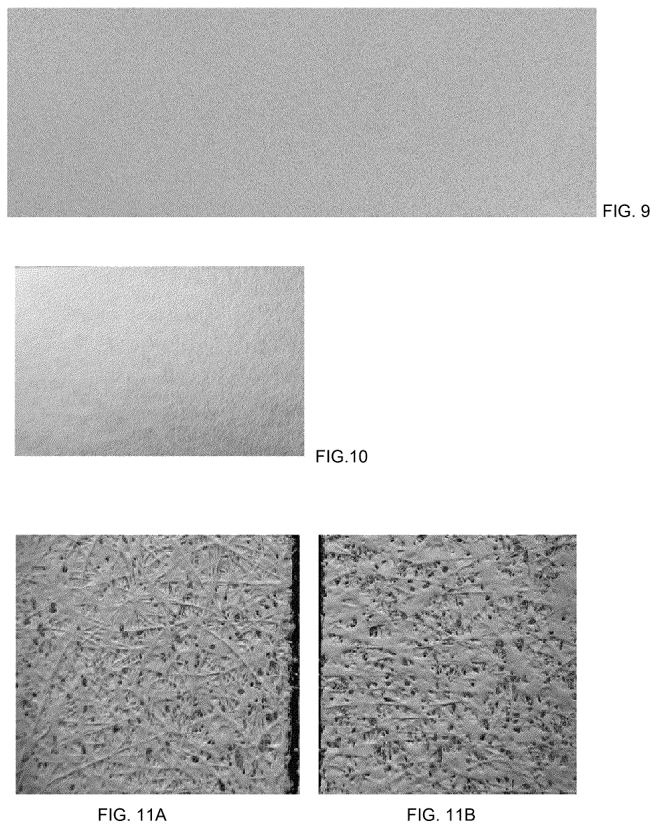

The present invention acoustical panel of a basemat and Veil B with two layers of the front coating is shown with minimal peppering and minimal patchiness in the photograph of FIG. 9.

FIG. 10 is a photo of uncoated Veil B that was under harsh lighting. It shows patchiness.

### Example 4

FIGS. 11A and 11B are photographs of acoustical panels with basemats and Veil A and a front coating. One layer of 16 g/ft² of the front coating is shown in FIG. 11A and two layers (8 g/ft² each) is shown in FIG. 11B.

If the same amount of total coating is split into two layers with drying following each pass, a different surface morphology is observed. While the first layer of the front coating lays substantially flat on the veil, the second layer tends to have droplets of front coating that sit on top of the first layer.

Despite the same total usage, the one layer front coating showed more blocking by coating, while the two layer of front coating has a more “open” structure with pores, which tends to create higher NRC.

### Example 5

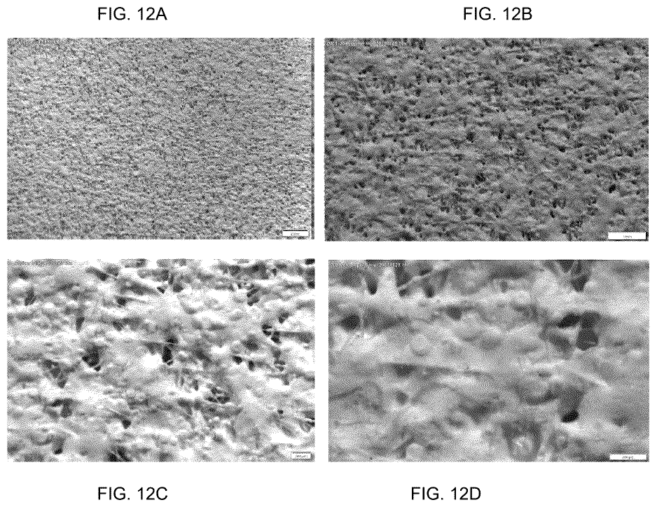

FIGS. 12A, 12B, 12C, 12D show an acoustical panel according to the present invention with a basemat and Veil A and two layers of the front coating (each layer 9 g/ft²). FIG. 12A is 7×, FIG. 12B is 20×, FIG. 12C is 50× and FIG. 12D is 100× magnification.

The microscope images (FIGS. 12A, 12B, 12C, 12D) show that with two layers of front coating, the second layer of front coating droplets can be visible under higher magnification, suggesting that coating droplets deposited onto the first coating layer do not spread out as much. The droplet size is 50-100 μm based on these images.

### Example 6

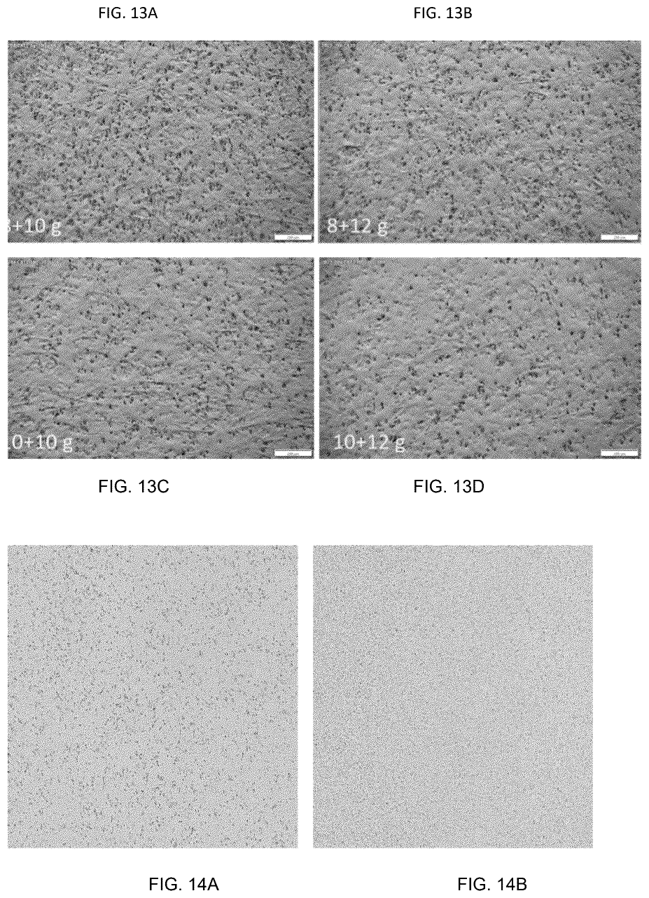

FIGS. 13A, 13B, 13C, 13D are magnified photographs of the acoustical panels of the present invention with a basemat, Veil A and 2 layers of front coating. Two layers of the front coating were sprayed in slightly different ratio. FIGS. 10A, 10B, 10C, 10D show a basemat with Veil A with various two layers of front coating application rates. FIG. 13A (8 g/ft² for the first pass, 10 g/ft² for the second pass) had the best overall visual appearance. In addition, compared to FIGS. 13B and 13C (8+12 g/ft² and 10+10 g/ft², respectively), it creates a surface structure with more pores that are evenly distributed, which tends to translate into higher NRC, suggesting that slightly heavier second layer might be advantageous. Visual judgment suggested that (8+12) g/ft² appears to yield slightly better pore distribution than (10+10) g/ft². Visual judgment also suggested that (8+12) g/ft² appears to yield slightly better pore distribution than (12+8) g/ft² (not shown). FIG. 13D is the sample with the most coating and would have lower air permeability.

### Example 7

FIGS. 14A and 14B are photographs showing the prior art basemat with Comparative Veil C and a coating in FIG. 14A and the present invention's acoustical panel with basemat, Veil A and two layers of front coating in FIG. 14B. As seen, in FIG. 14B, the acoustical panel is aesthetically superior and meets all of the properties specified for noise reduction including NRC, CAC, and LR.

### CLAUSES OF THE INVENTION

The following clauses disclose aspects of embodiments of the invention.

Clause 1. An acoustical panel comprising:
a basemat,
a veil comprising:
   15-55 wt. % glass fibers,
   40-60 wt. % mineral filler, typically calcium carbonate and/or titanium dioxide,
   25-35 wt. %, preferably 28-32 wt. %, more preferably 30-31 wt %, binder, and
wherein the glass fibers have a number average length of about 5-10 mm, preferably 6-7 mm,
wherein a first portion of the glass fibers in the veil has a diameter of 10-11 μm,
wherein a second portion of the glass fibers in the veil has a diameter of 6-7 μm,
wherein the veil has a base weight of 100 g/m² to 200 g/m², preferably 120 g/m² to 180 g/m², more preferably 130 g/m² to 180 g/m²,
a front coating comprising filler and binder at a front face of the acoustical panel,
wherein the front coating has a first layer comprising the filler and the binder and a second layer comprising the filler and the binder,
wherein the second layer has a higher weight per surface area than the first layer,
wherein the first layer and the second layer is present at a total weight per surface area of 11 to 15.5 g/ft², preferably 12.5-15.5 g/ft² on a dry basis of the front face of the acoustical panel,
wherein the first layer of the front coating is about 4-7 g/ft², typically 5.5-6.5 g/ft² on a dry basis of the front face of the acoustical panel and wherein the second layer of the front coating is about 5.5 to 10 g/ft², preferably 5.5 to 7 g/ft² or preferably 7 to 8.5 g/ft² on a dry basis of the front face of the acoustical panel, and
wherein the first layer of the front coating as applied has droplets of an average droplet diameter from 10 μm to 160 μm, preferably 20 μm to 150 μm, preferably with a majority of the droplets 50 μm to 100 μm,
wherein the second layer of the front coating as applied has droplets of an average droplet diameter from 10 μm to 160 μm, preferably 20 μm to 150 μm, preferably with a majority of the droplets 50 μm to 100 μm,
wherein the layers of the front coating are substantially uniformly applied but do not form a continuous film;
wherein spots on the acoustical panel having cross-sectional area of less than 0.3 mm², preferably less than 0.2 mm², are present from 1.5% to 5%, preferably 2 to 4% of total area of the front face of the acoustical panel,
wherein a number mean cross-sectional area of the spots is greater than 0.002 mm² and up to 0.012 mm², preferably up to 0.008 mm², preferably up to 0.006 mm², and
wherein a total area darkened with shadows and/or the spots is 1.5 to 17%, preferably 2 to 17%, more preferably 3 to 16%, furthermore preferably 3 to 15% of the total area of the front face of the acoustical panel.

Clause 2. The acoustical panel of clause 1, wherein the acoustical panel is a high noise reduction acoustical panel having an NRC is 0.90 or higher:
wherein the basemat comprises mineral wool, or glass wool, or a combination of mineral wool and glass wool; filler; and binder,
wherein the mineral wool, the glass wool, or the combination of mineral wool and glass wool of the basemat have a number mean diameter of at least 6 microns and is present in an amount of at least 80 wt. %, preferably at least 90 wt. %, based on the total weight of the basemat as dried, and
the binder of the basemat is present in an amount of about 4 wt. % to about 13 wt. %, preferably between about 4 wt. % and about 10 wt. %, based on the total dry weight of the basemat,
the basemat having a density of about 9 to 12.5 lb/ft3,
wherein the basemat is provided as a single layer having a thickness of 1 inch to 1.5 inches;
wherein the veil comprises:
   15-55 wt. % glass fibers,
   40-60 wt. % mineral filler, typically calcium carbonate and/or titanium dioxide, and
   25-35 wt. %, preferably 28-32 wt. %, more preferably 30-31 wt %, binder,
   wherein the binder preferably comprises cured polyvinyl alcohol binder and optionally cured styrene-acrylic polymer binder,
wherein the glass fibers have number average length of about 5-10 mm, preferably 6-7 mm,
wherein the first portion of the glass fibers in the veil has the diameter of 10-11 μm,
wherein the second portion of the glass fibers in the veil has the diameter of 6-7 μm; and
wherein the front coating results from the drying of a coating composition applied comprising:
   30-90 wt. % filler selected from particles of calcium carbonate, dolomite, titanium dioxide, barium sulfate, clay, mica, limestone, silica, talc, perlite, gypsum, wollastonite, calcite, aluminum trihydrate, a pigment and a combination thereof, and
   1-20 wt. % binder selected from a natural polymer, a modified natural polymer, a synthetic polymer and a combination thereof, preferably a polymer aqueous emulsion of vinyl acetate-acrylate,
   10-30 wt. % carrier comprising water, and
   1-10 wt. % optional additives.

Clause 3. The acoustical panel of clauses 1 or 2, wherein the glass fibers of the veil are in a substantially uniform random orientation.

Clause 4. A nondirectional acoustical panel comprising:
a basemat,
a veil comprising:
   15-55 wt. % glass fibers,
   40-60 wt. % mineral filler, typically calcium carbonate and/or titanium dioxide, and
   25-35 wt. %, preferably 28-32 wt. %, more preferably 30-31 wt %, binder, wherein the glass fibers have a number average length of about 5-10 mm, preferably 6-7 mm,
wherein a first portion of the glass fibers in the veil has a diameter of 10-11 μm,
wherein a second portion of the glass fibers in the veil has a diameter of 6-7 μm,
wherein the glass fibers are in a substantially uniform random orientation,
wherein the veil has a base weight of 100 g/m² to 200 g/m², preferably 120 g/m² to 180 g/m², more preferably 130 g/m² to 180 g/m², a front coating comprising filler and binder at a front face of the acoustical panel,
wherein the front coating has a first layer and a second layer,
wherein the second layer has a higher weight per surface area than the first layer.

Clause 5. The acoustical panel of clause 4, wherein the second layer has a higher weight per surface area than the first layer.

Clause 6. The acoustical panel of any of clauses 1 to 5, wherein the first portion of glass fibers are 5 to 50 wt. % of the veil and the second portion of glass fibers are 5 to 50 wt. % of the veil, typically wherein the first portion of glass fibers are 10 to 45 wt. % of the veil and the second portion of glass fibers are 10 to 45 wt. % of the veil.

Clause 7. The acoustical panel of any of clauses 1 to 6, wherein less than 5%, preferably less than 4%, preferably less than 2%, more preferably 0% of the surface area of the acoustical panel has patches.

Clause 8. The acoustical panel of any of clauses 1 to 7, wherein the veil has a tensile MD (N/50 mm) of >210, tensile CD (N/50 mm)>190, and an air flow permeability of 1000-1200, preferably 1050 L/m2/s at 100 Pa.

Clause 9. The acoustical panel of any of clauses 1 to 8, wherein the filler of the front coating comprises a combination of 1-4 μm calcium carbonate particles and 5-10 μm calcium carbonate particles, in a weight ratio of 1.5:1 to 5.5:1.

Clause 10. The acoustical panel of any of clauses 1 to 9, wherein the filler of the front coating comprises calcium carbonate particles, at 30-70 wt. % of the front coating, and titanium dioxide particles, at 1-20 wt. % of the front coating, preferably wherein the titanium dioxide has a d50 of less than 50 microns.

Clause 11. The acoustical panel of any of clauses 1 to 10, wherein the basemat comprises mineral wool, glass wool, or a combination of mineral wool and glass wool; filler; and binder.

Clause 12. The acoustical panel of clause 11,
wherein the mineral wool, the glass wool, or the combination of mineral wool and glass wool of the basemat have a number mean diameter of at least about 6 microns and is present in an amount of at least 80 wt. %, preferably at least 90 wt. %, based on the total weight of the basemat as dried, and
the binder of the basemat is present in an amount of about 4 wt. % to about 13 wt. %, preferably between about 4 wt. % and about 10 wt. %, based on the total weight of the basemat as dried.

Clause 13. The acoustical panel of any of clauses 1 to 12, wherein the basemat is provided as a single layer having a thickness of ⅝ inches to 2 inches.

Clause 14. The acoustical panel of any of claims 1 to 13, wherein the front coating comprises 30-70 wt. % calcium carbonate, and 1-20 wt. % titanium dioxide.

Clause 15. The acoustical panel of any of clauses 1 to 14, wherein the CAC is 30 or higher.

Clause 16. The acoustical panel of any of clauses 1 to 15, wherein a total area of spots is less than 4% and/or the mean spot size is less than 0.015 mm.

Clause 17. The acoustical panel of any of clauses 1 to 16, having at least one property selected from the group consisting of:
scrubability is greater than 25 cycles, preferably 50-75 cycles;
water repellency is >30 minutes; and
LR is 0.85 or greater.

Clause 18. The acoustical panel of any of clauses 1 to 17, wherein the acoustical panel is a ceiling tile.

Clause 19. The acoustical panel of any of clauses 1 to 17, wherein the acoustical panel is a wall panel.

Clause 20. A process of manufacturing an acoustical panel of any clauses 1 to 19, comprising:
applying to a front side of the basemat a veil comprising:
   15-55 wt. % glass fibers,
   40-60 wt. % mineral filler, typically calcium carbonate and/or titanium dioxide,
   25-35 wt. %, preferably 28-32 wt. %, more preferably 30-31 wt %, binder, and
wherein the glass fibers have a number average length of about 5-10 mm, preferably 6-7 mm,
wherein a first portion of the glass fibers in the veil has a diameter of 10-11 μm,
wherein a second portion of the glass fibers in the veil has a diameter of 6-7 μm,
wherein preferably the glass fibers are in a substantially random orientation,
wherein the veil has a base weight of 100 g/m² to 200 g/m², preferably 120 g/m² to 180 g/m², more preferably 130 g/m² to 180 g/m²,
spray coating the veil with a first layer of a front coating comprising filler and binder at a front face of the acoustical panel, drying or substantially drying the first layer, wherein preferably the first layer of the front coating is applied and then dried in an oven;
then spray coating a second layer of the front coating comprising filler and binder to the first layer, wherein the first layer of the front coating may be the same or different in composition from the second layer of the front coating, preferably the first layer and the second layer have the same composition of the front coating,
wherein the second layer is applied with a greater weight per surface area than the first layer,
wherein a total of the first layer and the second layer of the front coating on a dry basis is present at from 11 to 15.5 g/ft², preferably 12.5-15.5 g/ft² on a dry basis of the front face of the acoustical panel;
wherein the first layer of the front coating is about 4-7 g/ft², typically 5.5-6.5 g/ft² on a dry basis of the front face of the acoustical panel, and the second layer of the front coating is about 5.5 to 10 g/ft², preferably 5.5 to 7 g/ft² or preferably 7 to 8.5 g/ft² on a dry basis of the front face of the acoustical panel resulting from:
applying the first layer and the second layer by the spray coating at a total weight per surface area of 16 to 22 g/ft² of the front face of the acoustical panel on a carrier inclusive basis,
wherein the first layer of the front coating is applied at a weight per surface area of 6-10 grams/square foot, preferably 8-9 g/ft² on a carrier inclusive basis, and the second layer of the front coating is applied at a weight per surface area of 8-14 g/ft², preferably 8 to 10 g/ft² or preferably 10-12 g/ft² of the front face of the acoustical panel on a carrier inclusive basis,
wherein the first layer of the front coating as applied has droplets of an average droplet diameter from 10 μm to 160 μm, preferably 20 μm to 150 μm, preferably with a majority of the droplets 50 μm to 100 μm,
wherein the second layer of the front coating as applied has droplets of an average droplet diameter from 10 μm to 160 μm, preferably 20 μm to 150 μm, preferably with a majority of the droplets 50 μm to 100 μm,
wherein the layers of the front coating are substantially uniformly applied but do not form a continuous film,
wherein spots on the acoustical panel having cross-sectional area of less than 0.3 mm², preferably less than 0.2 mm², are present from 1.5% to 5%, preferably 2 to 4% of total area of the front face of the acoustical panel,
wherein a number mean cross-sectional area of the spots is greater than 0.002 mm² and up to 0.012 mm², preferably up to 0.008 mm², preferably up to 0.006 mm² of the front face of the acoustical panel, and
wherein a total area darkened with shadows and/or the spots is 1.5 to 17%, preferably 2 to 17%, more preferably 3 to 16%, furthermore preferably 3 to 15% of the total area of the front face of the acoustical panel.

While particular versions of the invention have been shown and described, it will be appreciated by those skilled in the art that changes and modifications may be made thereto without departing from the invention in its broader aspects and as set forth in the following claims.

1. An acoustical panel comprising:
a basemat,
a veil comprising:
15-55 wt. % glass fibers,
40-60 wt. % mineral filler,
25-35 wt. % binder, and
wherein the glass fibers have a number average length of about 5-10 mm,
wherein a first portion of the glass fibers in the veil has a diameter of 10-11 μm,
wherein a second portion of the glass fibers in the veil has a diameter of 6-7 μm,
wherein the veil has a base weight of 100 g/m² to 200 g/m²,
a front coating comprising filler and binder at a front face of the acoustical panel,
wherein the front coating has a first layer comprising the filler and the binder and a second layer comprising the filler and the binder,
wherein the second layer has a higher weight per surface area than the first layer,
wherein the first layer and the second layer is present at a total weight per surface area of 11 to 15.5 g/ft² on a dry basis of the front face of the acoustical panel,
wherein the first layer of the front coating is about 4-7 g/ft², for example 5.5-6.5 g/ft² on a dry basis of the front face of the acoustical panel and wherein the second layer of the front coating is about 5.5 to 10 g/ft² on a dry basis of the front face of the acoustical panel,
wherein the first layer of the front coating as applied has droplets of an average droplet diameter from 10 μm to 160 μm,
wherein the second layer of the front coating as applied has droplets of an average droplet diameter from 10 μm to 160 μm; and
wherein the layers of the front coating are substantially uniformly applied but do not form a continuous film;
wherein spots on the acoustical panel having cross-sectional area of less than 0.3 mm² are present from 1.5% to 5% of total area of the front face of the acoustical panel,
wherein a number mean cross-sectional area of the spots is greater than 0.002 mm² and up to 0.012 mm², and
wherein a total area darkened with shadows and/or the spots is 1.5 to 17% of the total area of the front face of the acoustical panel.

2. The acoustical panel of claim 1, wherein the acoustical panel is a high noise reduction acoustical panel having an NRC is 0.90 or higher:
wherein the basemat comprises mineral wool, or glass wool, or a combination of mineral wool and glass wool; filler; and binder,
wherein the mineral wool, the glass wool, or the combination of mineral wool and glass wool of the basemat have a number mean diameter of at least 6 microns and is present in an amount of at least 80 wt. % based on the total weight of the basemat as dried, and
the binder of the basemat is present in an amount of about 4 wt. % to about 13 wt. % based on the total dry weight of the basemat,
the basemat having a density of about 9 to 12.5 lb/ft³,
wherein the basemat is provided as a single layer having a thickness of 1 inch to 1.5 inches;
wherein the veil comprises:
15-55 wt. % glass fibers,
40-60 wt. % mineral filler, and
25-35 wt. % binder,
wherein the glass fibers have number average length of about 5-10 mm,
wherein the first portion of the glass fibers in the veil has the diameter of 10-11 μm,
wherein the second portion of the glass fibers in the veil has the diameter of 6-7 μm; and
wherein the front coating results from the drying of a coating composition applied comprising:
30-90 wt. % filler selected from particles of calcium carbonate, dolomite, titanium dioxide, barium sulfate, clay, mica, limestone, silica, talc, perlite, gypsum, wollastonite, calcite, aluminum trihydrate, a pigment and a combination thereof, and
1-20 wt. % binder selected from a natural polymer, a modified natural polymer, a synthetic polymer and a combination thereof,
10-30 wt. % carrier comprising water, and
1-10 wt. % optional additives.

3. The acoustical panel of claim 1, wherein the glass fibers of the veil are in a substantially uniform random orientation.

4. A nondirectional acoustical panel comprising:
a basemat,
a veil comprising:
15-55 wt. % glass fibers,
40-60 wt. % mineral filler, and
25-35 wt. % binder,
wherein the glass fibers have a number average length of about 5-10 mm,
wherein a first portion of the glass fibers in the veil has a diameter of 10-11 μm,
wherein a second portion of the glass fibers in the veil has a diameter of 6-7 μm,
wherein the glass fibers are in a substantially uniform random orientation,
wherein the veil has a base weight of 100 g/m² to 200 g/m²,
a front coating comprising filler and binder at a front face of the acoustical panel,
wherein the front coating has a first layer and a second layer,
wherein the second layer has a higher weight per surface area than the first layer.

5. The acoustical panel of claim 4, wherein the second layer has a higher weight per surface area than the first layer.

6. The acoustical panel of claim 1, wherein the first portion of glass fibers are 5 to 50 wt. % of the veil and the second portion of glass fibers are 5 to 50 wt. % of the veil.

7. The acoustical panel of claim 1, wherein less than 5% of the surface area of the front face of the acoustical panel has patches.

8. The acoustical panel of claim 1, wherein the veil has a tensile MD (N/50 mm) of >210, tensile CD (N/50 mm)>190, and an air flow permeability of 1000-1200.

9. The acoustical panel of claim 1, wherein the filler of the front coating comprises a combination of 1-4 μm calcium carbonate particles and 5-10 μm calcium carbonate particles, in a weight ratio of 1.5:1 to 5.5:1.

10. The acoustical panel of claim 1, wherein the filler of the front coating comprises calcium carbonate particles, at 30-70 wt. % of the front coating, and titanium dioxide particles, at 1-20 wt. % of the front coating, preferably wherein the titanium dioxide has a d50 of less than 50 microns.

11. The acoustical panel of claim 1, wherein the basemat comprises mineral wool, glass wool, or a combination of mineral wool and glass wool; filler; and binder.

12. The acoustical panel of claim 11,
wherein the mineral wool, the glass wool, or the combination of mineral wool and glass wool of the basemat have a number mean diameter of at least about 6 microns and is present in an amount of at least 80 wt. % based on the total weight of the basemat as dried, and
the binder of the basemat is present in an amount of about 4 wt. % to about 13 wt. % based on the total weight of the basemat as dried.

13. The acoustical panel of claim 1, wherein the basemat is provided as a single layer having a thickness of ⅝ inches to 2 inches.

14. The acoustical panel of claim 1, wherein the front coating comprises 30-70 wt. % calcium carbonate, and 1-20 wt. % titanium dioxide.

15. The acoustical panel of claim 1, wherein the CAC is 30 or higher.

16. The acoustical panel of claim 1, wherein a total area of spots is less than 4% of the front face of the acoustical panel and/or the mean spot size is less than 0.015 mm.

17. The acoustical panel of claim 1, having at least one property selected from the group consisting of:
scrubability is greater than 25 cycles;
water repellency is >30 minutes; and
LR is 0.85 or greater.

18. The acoustical panel of claim 1, wherein the acoustical panel is a ceiling tile.

19. The acoustical panel of claim 1, wherein the acoustical panel is a wall panel.

20. A process of manufacturing an acoustical panel of claim 1, comprising:
applying to a front side of the basemat a veil comprising:
15-55 wt. % glass fibers,
40-60 wt. % mineral filler,
25-35 wt. % binder, and
wherein the glass fibers have a number average length of about 5-10 mm,
wherein a first portion of the glass fibers in the veil has a diameter of 10-11 μm,
wherein a second portion of the glass fibers in the veil has a diameter of 6-7 μm,
wherein the veil has a base weight of 100 g/m² to 200 g/m²,
spray coating the veil with a first layer of a front coating comprising filler and binder, drying or substantially drying the first layer;
then spray coating a second layer of the front coating comprising filler and binder to the first layer, wherein the first layer of the front coating may be the same or different in composition from the second layer of the front coating,
wherein the second layer is applied with a greater weight per surface area than the first layer,
wherein a total of the first layer and the second layer of the front coating on a dry basis is present at from 11 to 15.5 g/ft² on a dry basis of the front face of the acoustical panel;
wherein the first layer of the front coating is about 4-7 g/ft² on a dry basis of the front face of the acoustical panel, and the second layer of the front coating is about 5.5 to 10 g/ft² or preferably 7 to 8.5 g/ft² on a dry basis of the front face of the acoustical panel resulting from:
applying the first layer and the second layer by the spray coating at a total weight per surface area of 16 to 22 g/ft² of the front face of the acoustical panel on a carrier inclusive basis,
wherein the first layer of the front coating is applied at a weight per surface area of 6-10 grams/square foot on a carrier inclusive basis, and the second layer of the front coating is applied at a weight per surface area of 8-14 g/ft² of the front face of the acoustical panel on a carrier inclusive basis,
wherein the first layer of the front coating as applied has droplets of an average droplet diameter from 10 μm to 160 μm,
wherein the second layer of the front coating as applied has droplets of an average droplet diameter from 10 μm to 160 μm,
wherein the layers of the front coating are substantially uniformly applied but do not form a continuous film,
wherein spots on the acoustical panel having cross-sectional area of less than 0.3 mm² are present from 1.5% to 5% of total area of the front face of the acoustical panel,
wherein a number mean cross-sectional area of the spots is greater than 0.002 mm² and up to 0.012 mm² of the front face of the acoustical panel, and
wherein a total area darkened with shadows and/or the spots is 1.5 to 17% of the total area of the front face of the acoustical panel.
